(19) United States
(12) Patent Application Publication
(10) Pub. No.: US 2025/0181131 A1
(43) Pub. Date: Jun. 5, 2025

(54) TECHNIQUES FOR SUPPLYING POWER AND DATA CENTER THEREOF

(71) Applicants: Seung Hoon PARK, Fremont, CA (US); Epsilon.X, Inc., Uiwang-si (KR)

(72) Inventors: Ji Won Suh, Seoul (KR); Chi Ho Song, Gwacheon-si (KR); Jin Hyoung kim, Hanam-si (KR)

(73) Assignees: Seung Hoon PARK, Fremont, CA (US); Epsilon.X, Inc., Uiwang-si (KR)

(21) Appl. No.: 18/964,730

(22) Filed: Dec. 2, 2024

(30) Foreign Application Priority Data
Dec. 1, 2023 (KR) 10-2023-0172188
Dec. 1, 2023 (KR) 10-2023-0172189
Oct. 2, 2024 (KR) 10-2023-0134107

(51) Int. Cl. G06F 1/26; H02J 7/06; H02M 1/00

(52) U.S. Cl. CPC G06F 1/26; H02J 7/06; H02M 1/0019; H02M 1/008; H02J 2207/50

(57) ABSTRACT

Various embodiments of a power supply technology and a data center using it are disclosed. In one embodiment, a power supply apparatus may comprise: an AC generator configured to generate a first alternating current (AC); a first converter configured to convert at least a portion of the first AC into a first direct current (DC); an energy storage unit configured to charge energy based on the first AC; a second converter configured to convert DC provided from the energy storage unit into a second DC; and a DC supplying unit capable of providing a third DC, which includes the first DC and the second DC, to at least one load.

### CROSS REFERENCE TO RELATED APPLICATION

The present application claims priority to Korean Patent Application No. 10-2023-0172188, filed on Dec. 1, 2023, Korean Patent Application No. 10-2023-0172189, filed on Dec. 1, 2023, and Korean Patent Application No. 10-2024-0134107, filed on Oct. 2, 2024, the entire contents of which are incorporated herein for all purposes by this reference.

### BACKGROUND

### Technical Field

This disclosure relates to power supply technology, and more particularly, some embodiments relate to power supply technology for data centers. Furthermore, some embodiments relate to an electronic equipment rack for efficiently supplying power to information technology (IT) components that consume large amounts of power unpredictably, such as AI (Artificial Intelligence) inference servers mounted in an electronic equipment rack in a data center.

### Description of the Related Art

Due to the increase in various data services, advancement of AI technology, and growing demand for AI technology, data centers require server systems capable of processing more data and the power infrastructure to support them.

For example, since the launch of ChatGPT, there has been a surge in demand for AI computing. To address this, companies worldwide are securing their own models through Large Language Models (LLM) to provide LLM-based AI services to customers. This may require numerous high-performance AI training/inference server racks. Specifically, while previous server racks had low power requirements (for example, 3-4 kW per rack), current high-performance server racks (for example, server racks performing LLM-supporting AI training/inference computing) may require significantly higher power (for example, 30 kW-100 kW). Furthermore, as AI technology and services become more sophisticated in data centers, more of these high-performance server racks may be needed.

Meanwhile, data centers with numerous high-performance server racks may require correspondingly higher power capacity. However, modifying existing data centers to meet these increased power requirements (for example, obtaining permits to increase power supply, implementing power distribution upgrades, etc.) or securing dedicated power plants for such data centers may not be practically feasible (for example, in terms of cost, permits/regulations, etc.) and may be inefficient (for example, requiring data center modifications or power plant procurement every time the data center expands or changes).

Additionally, power demand in each data center can significantly fluctuate by time period. For example, in data centers responsible for AI inference, the number of connected users and service demand volume can vary considerably by time period, resulting in corresponding significant power fluctuations. Specifically, there can be substantial differences between average power demand and peak power demand, and particularly in AI inference computing, as opposed to AI training, predicting such power requirements in advance may be impossible. To address this need, one could consider a method to always ensure power supply from a power plant that exceeds the peak demand. However, as mentioned above, there are issues related to permits and power distribution, and even if power distribution is feasible, it may come with high costs (e.g., tiered electricity pricing).

### SUMMARY

Accordingly, there may be a need for technology that can efficiently supply power to data centers requiring higher amounts of power with unpredictable power demands. Additionally, there may be a need for a system that includes a server rack integrated with power supply technology to efficiently provide supplementary power to servers in such data centers.

An aspect of the present disclosure provides a power supply apparatus for supplying power to at least one load, comprising: an AC generator configured to generate a first alternating current (AC); a first converter configured to convert at least a portion of the first AC into a first direct current (DC); an energy storage unit configured to charge energy based on the first AC; a second converter configured to convert DC provided from the energy storage unit into a second DC; and a DC supplying unit capable of providing a third DC, which includes the first DC and the second DC, to the at least one load.

In some embodiments, the power supply apparatus may further comprise: a monitoring unit configured to provide monitoring information for detecting the required power of the at least one load; and a controller configured to control at least one of the second converter and the DC supplying unit based on the monitoring information.

In some embodiments, the AC generator may generate the first AC based on AC provided from an AC power source.

In some embodiments, the AC generator may generate the first AC by limiting power of the first AC to be equal to or less than a predetermined first threshold.

In some embodiments, the monitoring unit may measure the current of the third DC provided to the at least one load, and the monitoring information may include information about the measured current.

In some embodiments, the controller may activate the second converter to generate the second DC when the detected required power is equal to or greater than a predetermined second threshold.

In some embodiments, the first threshold may be greater than the second threshold.

In some embodiments, the DC supplying unit may comprise: a first power delivery path connecting the first converter and the at least one load so that the first DC can be delivered to the at least one load; a second power delivery path connecting the output of the second converter to a first junction point; and a first switch for opening and closing the second power delivery path.

In some embodiments, the first junction point may be a point included in the first power delivery path where the first DC and the second DC can be combined.

In some embodiments, the controller may control the opening and closing of the first switch based on the monitoring information. In some embodiments, the controller may control the first switch to close when the detected required power based on the monitoring information is equal to or greater than the predetermined second threshold. In some embodiments, after controlling the first switch to close, the controller may control the first switch to open when the detected required power based on the monitoring information becomes less than the second threshold, and may control the energy storage unit so that the energy storage unit can be charged.

In some embodiments, the power supply apparatus may share a power bus with at least one other power supply apparatus. In some embodiments, the power supply apparatus may further comprise: a third power delivery path connecting the output of the second converter and the power bus so that the second DC can be delivered to the power bus; and a fourth power delivery path for providing power from the power bus to the at least one load.

In some embodiments, the power supply apparatus may further comprise a second switch for opening and closing the third power delivery path, and the controller may control the opening and closing of the second switch.

In some embodiments, the power supply apparatus may further comprise a third switch for opening and closing the fourth power delivery path and the controller may control the opening and closing of the third switch.

In some embodiments, the controller may control the opening and closing of the first switch, the second switch, and the third switch, and control charging of the energy storage unit based on at least some of the monitoring information, charge amount of the energy storage unit, and information received from at least one of the at least one other power supply apparatus.

In some embodiments, the controller may control the opening and closing of the second switch based on the monitoring information and information received from at least one of the at least one other power supply apparatus.

In some embodiments, the controller may control the second switch to close when the detected required power based on the monitoring information is less than the predetermined second threshold, required power of the at least one other power supply apparatus is equal to or greater than the second threshold, and charge amount of the energy storage unit of the at least one other power supply apparatus is less than a predetermined third threshold.

In some embodiments, after controlling the second switch to close, the controller may control the energy storage unit so that energy storage unit can be charged when the detected required power based on the monitoring information remains less than the second threshold, the required power of the at least one other power supply apparatus becomes less than the second threshold, and the charge amount of the energy storage unit of the at least one other power supply apparatus becomes equal to or greater than a predetermined fourth threshold.

In some embodiments, the controller may control the opening and closing of the third switch based on the monitoring information and charge amount of the energy storage unit.

In some embodiments, the controller may control the third switch to close when the detected required power based on the monitoring information is equal to or greater than the predetermined second threshold and the charge amount of the energy storage unit is less than a predetermined third threshold.

In some embodiments, after controlling the third switch to close, the controller may control the third switch to open, and control the energy storage unit so that the energy storage unit can be charged, when the required power detected based on the monitoring information is less than the second threshold and the charge amount of the energy storage unit is less than a predetermined third threshold.

In some embodiments, the fourth power delivery path may comprise a path connecting the power bus and a second junction point, and the third DC may further comprise DC provided from the power bus to the second junction point. In some embodiments, the second junction point may be a point included in the first power delivery path.

In some embodiments, the energy storage unit may comprise: a third converter configured to convert at least a portion of the first AC into DC; and an energy storage system configured to charge energy using the DC supplied from the third converter.

In some embodiments, the controller may control charging of the energy storage unit by activating or deactivating the third converter.

In some embodiments, the energy storage system may comprise at least one energy storage cell using a material other than a metal oxide as a cathode active material.

In some embodiments, the energy storage system may comprise at least one energy storage cell that stores energy without using a chemical reaction at the cathode.

In some embodiments, the energy storage system may comprise a Lithium Ion Capacitor (LIC).

In some embodiments, the at least one load may comprise at least one server system, and the at least one server system may comprise at least one server.

Another aspect of the present disclosure provides a data center system comprising: at least one subsystem; and at least one server system receiving power from the at least one subsystem, wherein each of the at least one subsystem comprises: an AC generator configured to generate a first AC; a first converter configured to convert at least a portion of the first AC into a first DC; an energy storage unit configured to charge energy based on the first AC; a second converter configured to convert DC provided from the energy storage unit into a second DC; and
a DC supplying unit capable of providing a third DC, which includes the first DC and the second DC, to the corresponding server system.

In some embodiments, each of the at least one server system may comprise: a power receiving unit capable of receiving the third DC; and at least one server.

In some embodiments, each of the at least one subsystem may further comprise: a monitoring unit configured to provide monitoring information for detecting the required power of the at least one server; and a controller configured to control at least one of the second converter and the DC supplying unit based on the monitoring information.

In some embodiments, the power receiving unit may comprise a DC bus connected to the at least one server.

Yet another aspect of the present disclosure provides a power supply apparatus for supplying power to at least one load. The power supply apparatus may comprising: an AC generator that generates a first AC; an energy storage unit that charges energy based on the first AC; a first converter that converts a first DC provided from the energy storage unit into a second AC; an AC supplying unit capable of providing a third AC, which includes the first AC and the second AC, to the at least one load.

In some embodiments, the power supply apparatus may further comprise: a monitoring unit configured to provide monitoring information for detecting the required power of the at least one load; and a controller configured to control at least one of the first converter and the AC supplying unit based on the monitoring information.

In some embodiments, the AC generator may generate the first AC based on an AC provided from an AC power source.

In some embodiments, the AC generator may generate the first AC by limiting its power to be equal to or less than a predetermined first threshold.

In some embodiments, the monitoring unit may measure the current of the third AC provided to the at least one load, and the monitoring information may include information regarding the measured current.

In some embodiments, the controller may activate the first converter to generate the second AC when the detected required power based on the monitoring information is equal to or greater than a predetermined second threshold.

In some embodiments, the first threshold may be greater than the second threshold.

In some embodiments, the AC supplying unit may comprise: a first power delivery path connecting the AC generator and the at least one load so that the first AC can be delivered to the at least one load; a second power delivery path connecting the output of the first converter to a first junction point; and a first switch for opening and closing the second power delivery path.

In some embodiments, the first junction point may be a point included in the first power delivery path where the first AC and the second AC can be combined.

In some embodiments, the controller may control the opening and closing of the first switch based on the monitoring information.

In some embodiments, the controller may control the first switch to close when the detected required power based on the monitoring information is equal to or greater than the predetermined second threshold.

In some embodiments, the power supply apparatus may further comprise: a third power delivery path connecting the output of the first converter to a power bus shared with at least one other power supply apparatus, so that the second AC can be delivered to the power bus; and a fourth power delivery path for providing power from the power bus to the at least one load.

In some embodiments, the power supply apparatus may further comprise: a second switch for opening and closing the third power delivery path; and the controller controls the opening and closing of the second switch.

In some embodiments, the power supply apparatus may further comprise a third switch for opening and closing the fourth power delivery path, and the controller controls the opening and closing of the third switch.

In some embodiments, the controller may control the opening and closing of the first switch, the second switch, and the third switch, and control charging of the energy storage unit based on at least some of the monitoring information, charge amount of the energy storage unit, and information received from at least one of the at least one other power supply apparatus.

In some embodiments, the controller may control the opening and closing of the second switch based on the monitoring information and information received from at least one of the at least one other power supply apparatus.

In some embodiments, the controller may control the second switch to close when the detected required power based on the monitoring information is less than the predetermined second threshold, required power of the at least one other power supply apparatus is equal to or greater than the second threshold, and charge amount of the energy storage unit of the at least one other power supply apparatus is less than a predetermined third threshold.

In some embodiments, after controlling the second switch to close, the controller may control the energy storage unit so that energy storage unit can be charged when the detected required power based on the monitoring information remains less than the second threshold, the required power of the at least one other power supply apparatus becomes less than the second threshold, and the charge amount of the energy storage unit of the at least one other power supply apparatus becomes equal to or greater than a predetermined fourth threshold.

In some embodiments, the controller may control the opening and closing of the third switch based on the monitoring information and the charge amount of the energy storage unit.

In some embodiments, the controller may control the third switch to close when the detected required power based on the monitoring information is equal to or greater than the predetermined second threshold and the charge amount of the energy storage unit is less than a predetermined third threshold.

In some embodiments, after controlling the third switch to close, the controller may control the third switch to open, and control the energy storage unit so that the energy storage unit can be charged, when the required power detected based on the monitoring information is less than the second threshold and the charge amount of the energy storage unit is less than a predetermined third threshold.

In some embodiments, the fourth power delivery path may include a path connecting the power bus and a second junction point, and the third AC may further include AC provided from the power bus to the second junction point.

In some embodiments, the second junction point may be a point included in the first power delivery path.

In some embodiments, the controller may control the first converter so that the second AC substantially matches the first AC at least in terms of phase and frequency.

In some embodiments, the first converter may comprise a grid-type inverter.

In some embodiments, the energy storage unit may comprise: a second converter configured to convert at least a portion of the first AC into DC; and an energy storage system configured to receive the DC from the second converter and charges energy.

In some embodiments, the controller may control charging of the energy storage unit by activating or deactivating the second converter.

In some embodiments, the energy storage system may comprise at least one energy storage cell using a material other than a metal oxide as a cathode active material.

In some embodiments, the energy storage system may comprise at least one energy storage cell that stores energy without using a chemical reaction at the cathode.

In some embodiments, the energy storage system may comprise a Lithium Ion Capacitor (LIC).

In some embodiments, the at least one load may comprise at least one server system, and the at least one server system may comprise at least one server.

Yet another aspect of the present disclosure provides a data center system comprising: at least one subsystem; and at least one server system receiving power from the at least one subsystem, wherein each of the at least one subsystem may comprise: an AC generator configured to generate a first AC; an energy storage unit configured to charge energy based on the first AC; a first converter configured to convert a first DC provided from the energy storage unit into a second AC; and an AC supplying unit capable of providing a third AC, which includes the first AC and the second AC, to the corresponding server system.

In some embodiments, each of the at least one server system may comprise: a power receiving unit capable of receiving the third AC; and at least one server.

In some embodiments, each of the at least one subsystem may further comprise: a monitoring unit configured to provide monitoring information for detecting the required power of the at least one load; and a controller configured to control at least one of the first converter and the AC supplying unit based on the monitoring information.

In some embodiments, the power receiving unit may comprise at least one DC supplying unit configured to generate a DC based on the third AC and supply the generated DC to the at least one server.

In some embodiments, the power receiving unit may further comprise a power distributor configured to distribute the third AC to the at least one DC supplying unit.

Yet another aspect of the present disclosure provides a system comprising: a current-limiting converter configured to receive power from an AC power source and output a first AC through at least one of a first output and a second output, while limiting the total power of the outputted first AC power to be equal to or less than a predetermined first threshold; L (where L is a natural number) first converters configured to convert AC based on the first output into a DC to output a first DC; a second converter configured to convert a AC based on the second output into a DC to output a second DC power; M (where M is a natural number) information technology (IT) components; N (where N is a natural number) energy storage units configured to charge power based on the second DC and can output a third DC by discharging the charged power; and a DC supplying unit that merges the first DC and the third DC power to provide a fourth DC to each of the M IT components.

In some embodiments, the system may further comprise a controller configured to control at least one of the N energy storage units to operate in a discharge mode when there is at least one over-power component among the M IT components that currently has a power consumption equal to or greater than a predetermined second threshold.

In some embodiments, the system may further comprise an electronic equipment rack capable of mounting at least some of the current-limiting converter, the L first converters, the second converter, the M IT components, the N energy storage units, the DC supplying unit, and the controller.

In some embodiments, the system may further comprise a power distributor configured to distribute the first AC output through the first output of the current-limiting converter to output second AC for each of the L first converters, and the AC based on the first output may include the second AC for each of the L first converters.

In some embodiments, L may have a value of 2 or more, and the power distributor may equally divide the first AC to provide it to each of the L first converters.

In some embodiments, the second threshold may be smaller than the value obtained by dividing the first threshold by M.

In some embodiments, the second threshold may be smaller than 80% of the value obtained by dividing the first threshold by M.

In some embodiments, each of the N energy storage units may comprise: an energy storage system configured to charge power based on the second DC; and a third converter configured to convert the DC obtained by discharging the power charged in the energy storage system into the third DC and output it.

In some embodiments, the energy storage system may comprise at least one energy storage cell that uses a material other than a metal oxide as a positive electrode material.

In some embodiments, the energy storage system may comprise at least one energy storage cell configured to store energy without using chemical reactions at the positive electrode.

In some embodiments, the energy storage system may comprise a Lithium Ion Capacitor (LIC).

In some embodiments, the energy storage system may include a supercapacitor.

In some embodiments, at least some of the M IT components may include servers for AI inference.

In some embodiments, the DC supplying unit may comprise a power bus bar connected to the outputs of each of the L first converters and each of the N energy storage units, and connected to the inputs of each of the M IT components.

In some embodiments, the system may further comprise a power supply apparatus that provides a fifth DC power to the DC supplying unit. In some embodiments, the power supply apparatus may comprise K (a natural number greater than N) second energy storage systems, and the fifth DC power may be based on the discharge of at least some of the K second energy storage systems.

Yet another aspect of the present disclosure provides a system comprising: an AC output unit configured to receive power from an AC power source and output a first AC through at least one of a first output and a second output; L (where L is a natural number) first converters configured to convert the AC power based on the first output into a DC to output a first DC power; a second converter configured to convert a AC based on the second output into a DC to output a second DC; M (where M is a natural number) IT components; N (where N is a natural number) energy storage units configured to charge power based on the second DC and output a third DC power by discharging the charged power; a DC supplying unit configured to merge the first DC and the third DC to provide a fourth DC to each of the M IT components; and a controller configured to control at least one of the N energy storage units to operate in a discharge mode when there is at least one over-power component among the M IT components that currently has a power consumption equal to or greater than a predetermined second threshold.

In some embodiments, the controller may control all of the N energy storage units to be in a mode other than the discharge mode when all of the M IT components have current power consumption less than the second threshold.

In some embodiments, the system may further comprise a current monitoring unit configured to measure the fourth DC input to each of the at least one IT component, and the controller may control the N energy storage units based on current measurement values provided from the current monitoring unit.

In some embodiments, the system may further comprise an electronic equipment rack capable of mounting at least some of the converter, the L first converters, the second converter, the M IT components, the N energy storage units, the DC supplying unit, and the controller.

In some embodiments, N may be a natural number of 2 or more, and the second converter may distribute the second DC to the N energy storage units under the control of the controller.

In some embodiments, the controller may control at least one energy storage unit operating in the discharge mode such that each over-power component receives power based on the first AC and power based on the third DC at a predetermined ratio.

In some embodiments, each energy storage unit among the N energy storage units currently assigned to each over-power component may output the third DC at a power value obtained by multiplying a predetermined constant by the current power consumption of the corresponding over-power component.

In some embodiments, each of the N energy storage units may include: an energy storage system configured to charge power based on the second DC; and a third converter configured to convert a DC obtained by discharging the power charged in the energy storage system into the third DC and outputs it.

In some embodiments, the controller may control the third converter to be activated so that the corresponding energy storage unit operates in the discharge mode.

In some embodiments, the controller may control the third converter of each energy storage unit among the N energy storage units currently assigned to each over-power component to output the third DC at a power value obtained by multiplying a predetermined constant by the current power consumption of the corresponding over-power component.

In some embodiments, the controller may control the second converter so that an energy storage unit among the N energy storage units that needs to be charged can be charged when all of the M IT components have current power consumption less than the second threshold.

In some embodiments, when there is an energy storage unit operating in the discharge mode among the energy storage units in which the amount of charge is smaller than a predetermined third threshold, the controller may control the corresponding energy storage unit to operate in a mode other than the discharge mode, and control at least one energy storage unit among the remaining energy storage units among the N energy storage units operating in a mode other than the discharge mode to operate in the discharge mode.

In some embodiments, the DC supplying unit may comprise a power bus bar connected to the outputs of each of the L first converters and each of the N energy storage units, and connected to the inputs of each of the M IT components.

In some embodiments, the system may further comprise a power supply apparatus that provides a fifth DC to the DC supplying unit. In some embodiments, the power supply apparatus may include K (a natural number greater than N) second energy storage systems, and the fifth DC may be based on the discharge of at least some of the K second energy storage systems.

In some embodiments, the power supply apparatus may further comprise: a fourth converter configured to convert the output currents of the K second energy storage systems to generate the fifth DC; and a second controller configured to control the discharge of the K second energy storage systems through activation control of the fourth converter.

In some embodiments, the power supply apparatus may further comprise a second communication unit capable of communicating with the controller, and the second controller may perform activation control of the fourth converter based on information provided from the second communication unit.

In some embodiments, the power supply apparatus may further comprise a second current monitoring unit configured to monitor the output currents of the K energy storage systems, and the second controller may perform activation control of the fourth converter based on the output currents monitored by the second current monitoring unit.

In some embodiments, the DC supplying unit may comprise a power bus bar connected to the outputs of each of the L first converters and each of the N energy storage units, and connected to the inputs of each of the M IT components, and the output of the fourth converter may be connected to the power bus bar so that the fifth DC can be merged with the first DC and the third DC.

In some embodiments, the system may further comprise: a first electronic equipment rack capable of mounting at least some of the converter, the L first converters, the second converter, the M IT components, the N energy storage units, the DC supplying unit, and the controller; and a second electronic equipment rack capable of mounting the fourth converter, the second controller, and the K second energy storage systems, where K may have a value greater than N.

This summary is provided to introduce a selection of concepts in a simplified form that are further described in the detailed description below. This summary is not intended to identify key or essential features of the claimed subject matter, nor is it intended to be used to limit the scope of the claimed subject matter. The claimed subject matter is not limited to implementations that solve any or all disadvantages noted in any part of this disclosure. In addition to the exemplary aspects, embodiments, and features described above, further aspects, embodiments, and features will become apparent from the following detailed description and accompanying drawings.

Some embodiments of this disclosure may have an effect including the following advantages. However, since it is not meant that all exemplary embodiments should include all of them, the scope of the present disclosure should not be understood as being limited thereto.

According to some embodiments, power can be efficiently supplied to data centers that require high power consumption and have unpredictable power demands.

According to some embodiments, power can be efficiently supplied to data centers where the average power demand and peak power demand differ significantly.

According to some embodiments, the necessary power can be adaptively supplied to servers without significant design changes to the server systems or server racks of the data center.

According to some embodiments, the necessary power can be adaptively supplied to server systems in the data center through a relatively simple interface.

According to some embodiments, the necessary power can be adaptively supplied to server racks that include IT components (e.g., AI inference servers) that may require large amounts of power and have unpredictable power demands.

According to some embodiments, the electricity costs of data centers can be reduced in situations where more power is required, power demands are unpredictable, or the difference between average power demand and peak power demand is significant.

According to some embodiments, power supply apparatus with long lifespans can be provided for data centers that require more power, have unpredictable power demands, or have significant differences between average power demand and peak power demand.

According to some embodiments, scalability can be maximized by providing modular power supply apparatuses for data centers that require more power, have unpredictable power demands, or have significant differences between average power demand and peak power demand.

According to some embodiments, scalability can be maximized by providing modular power supply apparatuses that can be mounted on electronic equipment racks for data centers that require more power, have unpredictable power demands, or have significant differences between average power demand and peak power demand.

According to some embodiments, power can be supplied more flexibly to match the instantaneous power demands of each server system through power sharing among multiple power supply apparatuses.

According to some embodiments, by effectively switching the charge and discharge modes of multiple energy storage units included in the server rack, power can be supplied more flexibly to match the instantaneous power demands of each server.

According to some embodiments, rapid response to power increases can be achieved by preemptively switching multiple energy storage units included in the server rack to discharge mode in anticipation of potential power consumption increases by the servers.

According to some embodiments, power outages due to excessive power consumption can be effectively prevented in data centers (e.g., data centers equipped with AI inference servers) where power outages frequently occur not only due to power failures or AC power source faults but also due to excessive power consumption, thereby eliminating or reducing the costs associated with securing unnecessarily high power (e.g., power purchase costs incurred by conservatively overestimating and pre-securing power consumption).

According to some embodiments, supplementary power supply technology with an optimal structure in terms of system complexity, efficiency, speed, and lifespan can be provided to server racks containing IT components (e.g., AI inference servers) that may require large amounts of power and have unpredictable power demands.

According to some embodiments, a stable and scalable data center can be constructed through a structure that provides staged responses to power supply failures.

### BRIEF DESCRIPTION OF THE DRAWINGS

FIG. 1 is a block diagram illustrating some embodiments of a data center according to the present disclosure.

FIG. 2 is a block diagram illustrating some embodiments of the power supply technology according to the present disclosure.

FIG. 3 is a block diagram illustrating some embodiments of a server system according to the present disclosure.

FIG. 4 is a block diagram illustrating other embodiments of a data center according to the present disclosure.

FIG. 5 is a block diagram illustrating other embodiments of the power supply technology according to the present disclosure.

FIG. 6 is a block diagram illustrating other embodiments of a server system according to the present disclosure.

FIG. 7 is a state transition diagram illustrating some embodiments of power supply control according to the present disclosure.

FIG. 8 is a block diagram illustrating some embodiments of a system according to the present disclosure.

FIG. 9 is a flowchart illustrating some embodiments of the operation of the system according to the present disclosure.

FIG. 10 is a block diagram illustrating further embodiments of a data center according to the present disclosure.

FIG. 11 is a block diagram illustrating further embodiments of the power supply technology according to the present disclosure.

### DETAILED DESCRIPTION OF THE DISCLOSURE

Since the description of the present disclosure is merely an exemplary embodiment for structural or functional description, the scope of the present disclosure should not be construed as being limited by the exemplary embodiments described in the text. That is, since exemplary embodiments may be changed in various ways and may have various forms, it should be understood that the right scope of the present disclosure includes equivalents that can realize the technical idea. In addition, the objectives or effects presented in the present disclosure may not mean that a specific exemplary embodiment should include all or only such effects, so the right scope of the present disclosure should not be understood as being limited thereto.

Meanwhile, the meaning of the terms described in the present disclosure should be understood as follows.

Terms such as “first”, “second”, and the like are intended to distinguish one component from another component, and the scope of rights should not be limited by these terms. For example, a first component may be referred to as a second component, and similarly, a second component may also be referred to as a first component.

When a component is referred to as being “connected” to another component, it may be directly connected to the other component, but it should be understood that other components may exist in the middle. On the other hand, when a component is referred to as being “directly connected” to another component, it should be understood that no other component exists in the middle. Meanwhile, other expressions describing the relationship between components, such as “between” and “immediately between” or “neighboring to” and “directly neighboring to”, should be interpreted in the same way.

Singular expressions should be understood to include plural expressions unless the context clearly indicates otherwise, and terms such as “include” or “have” are intended to designate the existence of features, numbers, steps, actions, components, parts, or combinations thereof, and should be understood not to preclude the possibilities of the existence or addition of one or more other features or numbers, steps, actions, components, parts, or combinations thereof.

In each step, identification codes (e.g., a, b, c, etc.) may be used for the convenience of explanation, and identification codes may not describe the order of each step, and each step may occur differently from the specified order unless a specific order is explicitly stated in the context. That is, each step may occur in the same order as the specified order, may be performed substantially simultaneously, or may be performed in the opposite order.

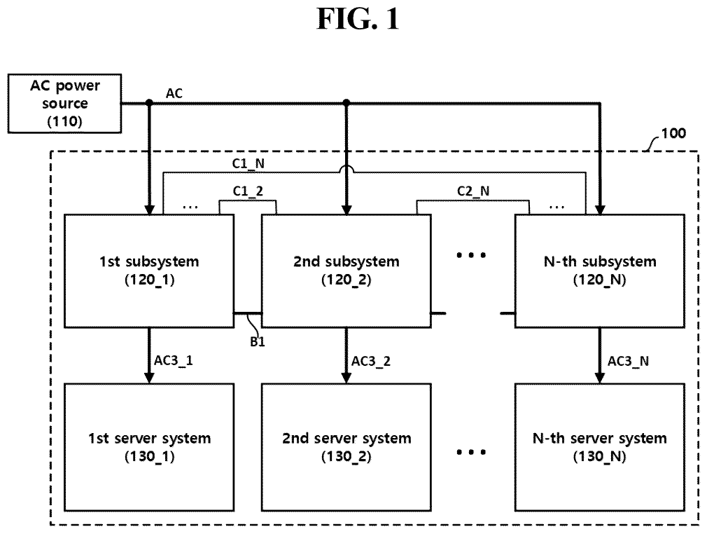

FIG. 1 is a block diagram illustrating some embodiments of a data center according to the present disclosure.

In some embodiments, as illustrated in FIG. 1, a data center system (100) may include at least one subsystem (120_1, 120_2, . . . , 120_N) configured to supply power and at least one server system (130_1, 130_2, . . . , 130_N) configured to receive power. In FIG. 1, N may have a value of a natural number.

Each subsystem (120_1, 120_2, . . . , 120_N) may receive power (AC) from an AC power source 110 (e.g., an AC grid) and supply power (AC3_1, AC3_2, . . . , AC3_N) to the respective server systems (130_1, 130_2, . . . , 130_N) using the power supply technology of the present disclosure.

The subsystems (120_1, 120_2, . . . , 120_N) may share a power bus (B1), through which they can supply or receive power.

The subsystems (120_1, 120_2, . . . , 120_N) may be equipped with communication means to exchange information (e.g., status information, control signals) with each other. In one embodiment of the communication means, as illustrated in FIG. 1, each subsystem (e.g., 120_1) may include data paths (C1_2, C1_3, . . . , C1_N) enabling one-to-one communication (wireless or wired) with other subsystems (e.g., 120_2, . . . , 120_N). In another embodiment of the communication means, the data center system may include a separate representative communication module (not shown), through which the representative communication module can receive information from each subsystem (120_1, 120_2, . . . , 120_N) and transmit it to the respective subsystems. In yet another embodiment of the communication means, each subsystem may share a data bus to exchange information with other subsystems. Each subsystem (120_1, 120_2, . . . , 120_N) may be mounted with its corresponding server system (130_1, 130_2, . . . , 130_N) in an electronic equipment rack (e.g., open rack or cabinet rack) to form a single unit system. For example, some or all of the modules included in subsystem 120_1 and server system 130_1 may be mounted in an electronic equipment rack to form a unit system. In this case, each unit system may communicate with other unit systems through data paths (C1_2, C1_3, . . . , C1_N) and may share the power bus (B1) to supply or receive power.

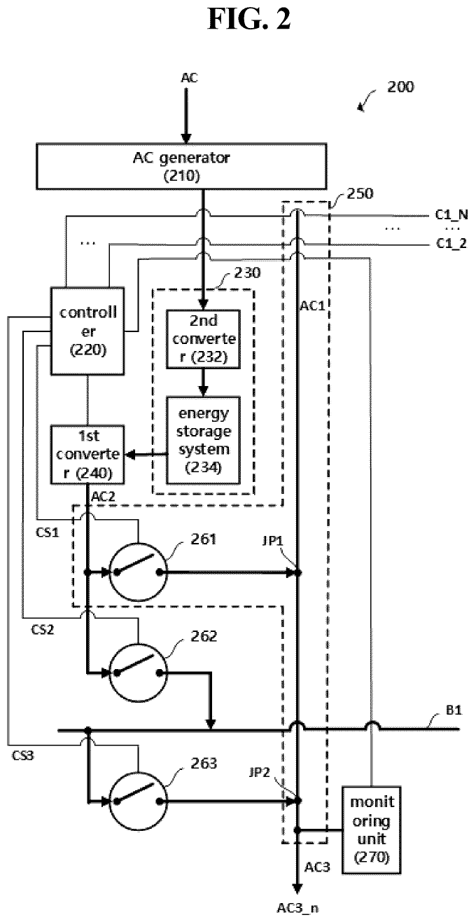

FIG. 2 is a block diagram illustrating some embodiments of the power supply technology according to the present disclosure.

In some embodiments, as illustrated in FIG. 2, a power supply apparatus 200 may include an AC generator 210, a controller 220, an energy storage unit 230, a first converter 240, an AC supplying unit 250, and a monitoring unit 270.

The power supply apparatus 200 may be used as each subsystem 120_n (where n is a natural number from 1 to N) illustrated in FIG. 1. The AC (AC3_n) generated by the power supply apparatus 200 may be provided to a load. The load may be each server system 130_n (where n is a natural number from 1 to N) illustrated in FIG. 1.

The data paths (for subsystem 130_1 in FIG. 1, C1_2, . . . , C_N) may enable the exchange of information between connected subsystems, and the information may include all or part of monitoring information to be described later (such as AC measurements, AC frequency, AC phase), the charge amount (e.g., state of charge) of the energy storage unit, and the open/closed status of first to third switches.

The AC generator 210 may generate a first AC (AC1). The AC generation unit 210 may generate the first AC (AC1) based on AC provided from an AC power source (e.g., the AC power source in FIG. 1). The AC generator 210 may limit the power of the first AC (AC1) to a predetermined first threshold. The AC generator 210 may be a current-limiting converter.

The energy storage unit 230 may charge energy based on the first AC (AC1). In some embodiments, as illustrated in FIG. 2, the energy storage unit 230 may include a second converter 232 and an energy storage system 234.

In one embodiment, as illustrated in FIG. 2, the second converter 232 may convert at least a portion of the first AC (AC1) into DC and supply the converted DC to the energy storage system 234. In another embodiment, unlike what is illustrated in FIG. 2, the second converter 232 may convert AC received from a separate AC source (not the AC generator 210) into DC and supply the converted DC to the energy storage system 234.

The second converter 232 may be an AC-DC charger.

The controller 220 may control the charging of the energy storage unit 230 by activating or deactivating the second converter 232.

The energy storage system 234 may receive DC from the second converter 232 and charge energy. In some embodiments, the energy storage system 234 may include at least one energy storage cell using a material other than metal oxides as the cathode material. In some embodiments, the energy storage system 234 may include at least one energy storage cell that stores energy without utilizing chemical reactions at the cathode. In some embodiments, the energy storage system 234 may include a supercapacitor. In some embodiments, the energy storage system 234 may include a Lithium Ion Capacitor (LIC).

Unlike lithium-ion batteries, which use metal oxides as cathode materials and perform battery charging and discharging through redox reactions, lithium-ion capacitors do not exhibit thermal runaway, thereby reducing the possibility of chain explosions or fires. Moreover, since lithium-ion capacitors perform charging and discharging through electric double-layer capacitor (EDLC) electrical reactions at the cathode, unlike lithium-ion batteries that rely on redox reactions, they can have a longer lifespan (i.e., more cycles of charging and discharging within normal ranges). Therefore, the power supply apparatus can be used for a long time even in environments where frequent charging and discharging are required due to significant fluctuations in the load's power demand.

The first converter 240 may convert a first DC provided from the energy storage unit 230 into a second AC (AC2). The first converter 240 may generate the second AC (AC2) that substantially matches the first AC (AC1) at least in terms of phase and frequency. The first converter 240 may include a grid-tied inverter. Through control by the controller 220, the first converter 240 may generate the second AC (AC2) that substantially matches the first AC (AC1) at least in phase and frequency. For example, the controller 220 may receive information on the phase and frequency of the first AC (AC1) from the monitoring unit 270 and provide it to the first converter 240. In another example, the controller 220 may control the first converter 240 to generate the second AC (AC2) that substantially matches the first AC (AC1) in phase and frequency based on information received from the monitoring unit 270. This ensures that when the combined third AC (AC3), which is the combination of the first AC (AC1) and the second AC (AC2), needs to be supplied to the load (e.g., when the load's power demand is high), the frequencies and phases of AC1 and AC2 are substantially matched, resulting in an optimal third AC (AC3) (i.e., minimizing coupling losses due to frequency or phase mismatches).

The AC supplying unit 250 may provide a third AC (AC3), which includes the first AC (AC1) and the second AC (AC2), to at least one load.

As described above, the optimized combination of the first AC (AC1) and the second AC (AC2) into the third AC (AC3) can efficiently provide appropriate power to loads requiring high instantaneous power through a single interface (i.e., without having separate interfaces for AC1 and AC2).

The at least one load may be each server system illustrated in FIG. 1.

The AC supplying unit 250 may include a first power delivery path connecting the AC generator 210 and the load to allow the first AC (AC1) to be delivered to the load, and a second power delivery path connecting the output of the first converter 240 and a first junction point (JP1). The first junction point (JP1) may be a point included in the first power delivery path where the first AC (AC1) and the second AC (AC2) can be combined.

As illustrated in FIG. 2, the AC supplying unit 250 may further include a first switch 261 for opening and closing the second power delivery path.

As illustrated in FIG. 2, the power supply apparatus 200 may share a power bus (B1) with at least one other power supply apparatus.

The power supply apparatus 200 may further include a third power delivery path connecting the output of the first converter 240 and the power bus (B1) so that the second AC (AC2) can be delivered to the power bus (B1). The power supply apparatus 200 may further include a second switch 262 for opening and closing this third power delivery path.

The power supply apparatus 200 may include a fourth power delivery path for providing power from the power bus (B1) to at least one load. The fourth power delivery path may include a path connected between the power bus (B1) and a second junction point (JP2). In this case, the third AC (AC3) may further include AC provided from the power bus (B1) to the second junction point (JP2). The second junction point (JP2) may be a point included in the first power delivery path. The power supply apparatus 200 may further include a third switch 263 for opening and closing the fourth power delivery path.

The monitoring unit 270 may provide monitoring information (M) for detecting required power of the load. The monitoring unit 270 may measure the current of the third AC (AC3) provided to the load, and the monitoring information (M) may include information about the measured current.

The controller 220 may control at least one of the first converter 240 and the AC supplying unit 250 based on the monitoring information (M) provided from the monitoring unit 270.

If the required power detected based on the monitoring information (M) is greater than or equal to a predetermined second threshold, the controller 220 may activate the first converter 240 to generate the second AC (AC2). The second threshold may be less than the first threshold (e.g., 80% of the first threshold) at which the AC generator limits the power of the first AC (AC1). This allows the system to switch to a mode that can proactively supply power in anticipation of the load's future high power demand.

The controller 220 may open and close the first switch 261 based on the monitoring information (M). For example, if the required power detected from the monitoring information (M) is greater than or equal to the predetermined second threshold, the controller 220 may control the first switch 261 to close.

The controller 220 may control the opening and closing of the second switch 262. The controller 220 may control the opening and closing of the second switch 262 based on the monitoring information (M) and information received from at least one other power supply apparatus.

Conditions for closing the second switch 262 may include a first condition where the controller 220 determines, based on the monitoring information (M), that there is sufficient power capacity in the power supply apparatus 200 to supply DC from the first converter 240 to the power bus (B1), and a second condition where at least one other power supply apparatus requires power from the power supply apparatus 200 via the power bus, based on information received from the other power supply apparatus. For example, the first condition may be that the current required power is below a predetermined value based on the monitoring information (M), and the charge amount of the energy storage unit 230 is above a predetermined value. The second condition may be met when power supply apparatus 200 receives, from at least one other power supply apparatus, information corresponding to the condition for closing its third switch or explicit power request, via the data paths (C1_2, . . . , and/or C1_N). Conditions for closing the third switch will be described later.

The controller 220 may control the opening and closing of the third switch 263. The controller 220 may control the third switch 263 based on the monitoring information (M) and the charge amount (e.g., state of charge) of the energy storage unit 230. In some embodiments, when the required power calculated from the monitoring information (M) is greater than or equal to a first predetermined value, and the charge amount of the energy storage unit 230 is less than a second predetermined value, the controller 220 may close the third switch 263 to further include the AC supplied from the power bus (B1) in the third AC (AC3). The first predetermined value may be the same as the aforementioned second threshold. The second predetermined value may be 30% of the full charge amount. In other embodiments, when the time during which the energy storage unit 230 can supply DC to the first converter 240 (e.g., the time until it is fully discharged) is within a predetermined time, the controller 220 may close the third switch 263 to further include the AC supplied from the power bus in the third AC (AC3). This allows the system to switch to a mode that can proactively supply power in anticipation of the load's future high power demand.

The controller 220 may transmit the monitoring information (M) and the charge amount of the energy storage unit 230 of the power supply apparatus to which the controller 220 belongs to other power supply apparatuses via the data paths (C1_2, . . . , and/or C1_N). The other power supply apparatuses receiving this information may determine whether to open or close their second switches based on the received information. The method for determining whether to open or close the second switch is as described above.

The controller 220 may explicitly transmit a power request to other power supply apparatuses. The controller 220 may determine whether to request power supply based on the monitoring information (M) and the charge amount (e.g., state of charge) of the energy storage unit 230. For example, if the required power calculated from the monitoring information (M) is greater than or equal to a first predetermined value and the charge amount of the energy storage unit 230 is less than a second predetermined value, the controller 220 may transmit a power request to other power supply apparatuses via the data paths (C1_2, . . . , and/or C1_N).

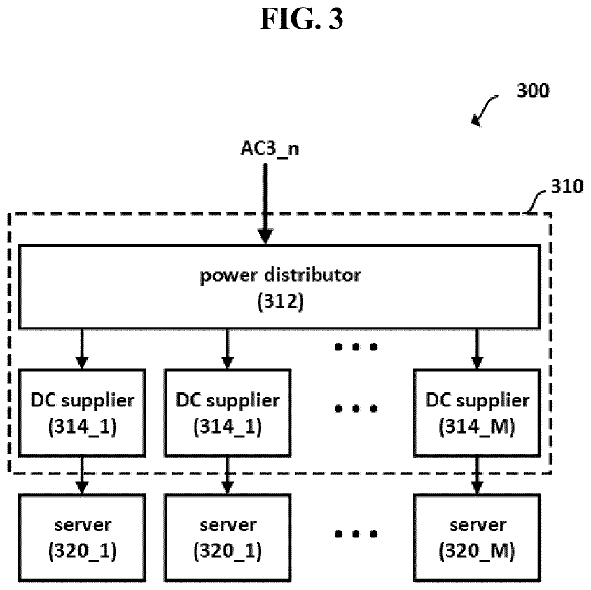

FIG. 3 is a block diagram illustrating some embodiments of a server system according to the present disclosure.

In some embodiments, as illustrated in FIG. 3, the server system 300 may include a power receiving unit 310 capable of receiving AC (e.g., third AC) generated by the power supply apparatus of the present disclosure and at least one server (314_1, 314_2, . . . , 314_M). In FIG. 3, M may be a natural number.

The server system 300 may be used as each server system 130_n (where n is a natural number from 1 to N) illustrated in FIG. 1.

The power receiving unit 310 may include at least one DC supplier (314_1, 314_2, . . . 314_M). The DC supplier (314_1, 314_2, . . . , 314_M) may generate DC based on the third AC (AC3_n) and supply it to the respective servers (324_1, 324_2, . . . , 324_M). The DC supplier (314_1, 314_2, . . . , 314_M) may be a power supply unit (PSU) included in a server rack.

In some embodiments, as illustrated in FIG. 3, the power receiving unit 310 may include at least one power distributor 312. The power distributor 312 may distribute the third AC to at least one DC supply unit (314_1, 314_2, . . . , 314_M). The power distribution unit 312 may be a power distribution unit (PDU) included in a server rack.

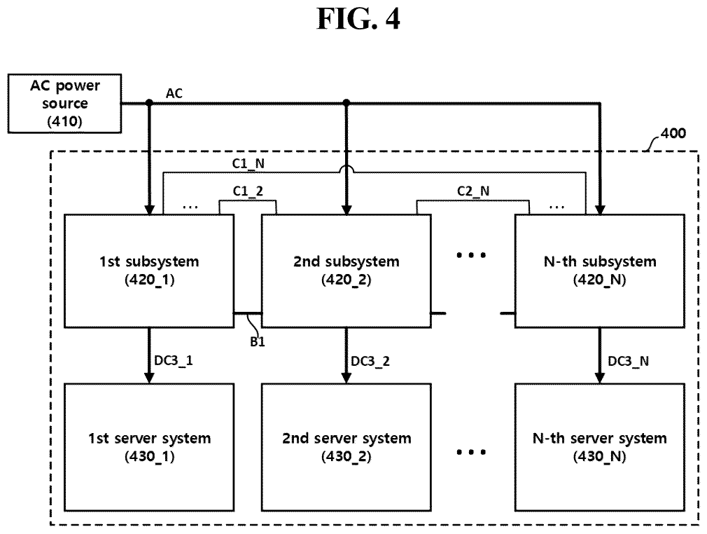

FIG. 4 is a block diagram illustrating other embodiments of a data center according to the present disclosure.

In some embodiments, as illustrated in FIG. 4, a data center system (400) may include at least one subsystem (420_1, 420_2, . . . 420_N) configured to supply power and at least one server system (430_1, 430_2, . . . , 430_N) configured to receive power. In FIG. 4, N may have a value of a natural number.

Each subsystem (420_1, 420_2, . . . , 420_N) may receive power (AC) from an AC power source 410 (e.g., an AC grid) and supply power (AC3_1, AC3_2, . . . , AC3_N) to the respective server systems (430_1, 430_2, . . . , 430_N) using the power supply technology of the present disclosure.

The subsystems (420_1, 420_2, . . . , 420_N) may share a power bus (B1), through which they can supply or receive power.

The subsystems (420_1, 420_2, . . . , 420_N) may be equipped with communication means to exchange information (e.g., status information, control signals) with each other. In one embodiment of the communication means, as illustrated in FIG. 4, each subsystem (e.g., 420_1) may include data paths (C1_2, C1_3, . . . , C1_N) enabling one-to-one communication (wireless or wired) with other subsystems (e.g., 420_2, . . . , 420_N). In another embodiment of the communication means, the data center system may include a separate representative communication module (not shown), through which the representative communication module can receive information from each subsystem (420_1, 420_2, . . . , 420_N) and transmit it to the respective subsystems. In yet another embodiment of the communication means, each subsystem may share a data bus to exchange information with other subsystems.

Each subsystem (420_1, 420_2, . . . , 420_N) may be mounted with its corresponding server system (430_1, 430_2, . . . , 430_N) in an electronic equipment rack (e.g., open rack or cabinet rack) to form a single unit system. For example, some or all of the modules included in subsystem 420_1 and server system 430_1 may be mounted in an electronic equipment rack to form a unit system. In this case, each unit system may communicate with other unit systems through data paths (C1_2, C1_3, . . . , C1_N) and may share the power bus (B1) to supply or receive power.

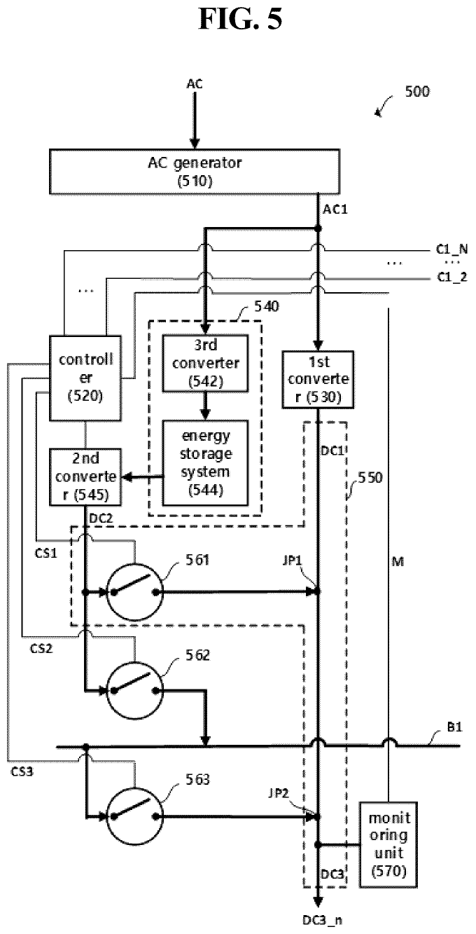

FIG. 5 is a block diagram illustrating other embodiments of the power supply technology according to the present disclosure.

In some embodiments, as illustrated in FIG. 5, the power supply apparatus 500 may include an AC generator 510, a controller 520, a first converter 530, an energy storage unit 540, a second converter 545, a DC supplying unit 550, and a monitoring unit 570.

The power supply apparatus 500 may be used as each subsystem 420_n (where n is a natural number from 1 to N) illustrated in FIG. 4. The DC (DC3_n) generated by the power supply apparatus 500 may be provided to a load. The load may be each server system 130_n (where n is a natural number from 1 to N) illustrated in FIG. 4.

The data paths (for subsystem 430_1 in FIG. 4, C1_2, . . . , C_N) may enable the exchange of information between connected subsystems, and the information may include all or part of monitoring information to be described later (e.g., DC measurements), the charge amount of the energy storage unit, and the open/closed status of first to third switches.

The AC generator 510 may generate a first AC (AC1). The AC generator 510 may generate the first AC (AC1) based on AC provided from an AC power source (e.g., the AC power source in FIG. 4). The AC generator 510 may limit the power of the first AC (AC1) to a predetermined first threshold. The AC generator 510 may be a current-limiting converter.

The first converter 530 may convert at least a portion of the first AC (AC1) into a first DC (DC1).

The energy storage unit 540 may charge energy based on the first AC (AC1). In some embodiments, as illustrated in FIG. 5, the energy storage unit 540 may include a third converter 542 and an energy storage system 544.

In one embodiment, as illustrated in FIG. 5, the third converter 542 may convert at least a portion of the first AC (AC1) into DC and supply the converted DC to the energy storage system 544. In another embodiment, unlike what is illustrated in FIG. 5, the third converter 542 may convert AC received from a separate AC source (not the AC generator 510) into DC and supply the converted DC to the energy storage system 544.

The third converter 542 may be an AC-DC charger.

The controller 520 may control the charging of the energy storage unit 540 by activating or deactivating the third converter 542.

The energy storage system 544 may receive DC from the third converter 542 and charge energy. The energy storage system 544 may include a supercapacitor. It may also include at least one energy storage cell that uses a material other than metal oxides as the cathode material. In some embodiments, the energy storage system 544 may include the energy storage cell described in FIG. 2 (e.g., a lithium-ion capacitor). This can provide the advantages described in FIG. 2.

The second converter 545 may convert DC provided from the energy storage unit 540 into a second DC (DC2).

The DC supplying unit 550 may provide a third DC (DC3), which includes the first DC (DC1) and the second DC (DC2), to at least one load. The optimized combination of the first DC (DC1) and the second DC (DC2) into the third DC (DC3) can efficiently provide appropriate power to loads requiring high instantaneous power through a single interface (i.e., without having separate interfaces for DC1 and DC2).

The at least one load may be each server system in FIG. 4.

The DC supplying unit 550 may include a first power delivery path connecting the first converter 530 and the at least one load to allow the first DC (DC1) to be delivered to the load, and a second power delivery path connecting the output of the second converter 545 and a first junction point (JP1). The first junction point (JP1) may be a point included in the first power delivery path where the first DC (DC1) and the second DC (DC2) can be combined.

The DC supplying unit 550 may further include a first switch 561 for opening and closing the second power delivery path.

The power supply apparatus 500 may share a power bus (B1) with at least one other power supply apparatus.

The power supply apparatus 500 may further include a third power delivery path connecting the output of the second converter 545 and the power bus (B1) so that the second DC (DC2) can be delivered to the power bus (B1). The power supply apparatus 500 may further include a second switch 562 for opening and closing this third power delivery path.

The power supply apparatus 500 may include a fourth power delivery path for providing power from the power bus (B1) to at least one load. The fourth power delivery path may include a path connected between the power bus (B1) and a second junction point (JP2). In this case, the third DC (DC3) may further include DC provided from the power bus (B1) to the second junction point (JP2). The second junction point (JP2) may be a point included in the first power delivery path. The power supply apparatus 500 may further include a third switch 563 for opening and closing the fourth power delivery path.

The monitoring unit 570 may provide monitoring information (M) for detecting required power of the load. The monitoring unit 570 may measure the current of the third DC (DC3) provided to the load, and the monitoring information (M) may include information about the measured current.

The controller 520 may control at least one of the second converter 545 and the DC supplying unit 550 based on the monitoring information (M) provided from the monitoring unit 570.

If the required power detected based on the monitoring information (M) is greater than or equal to a predetermined second threshold, the controller 520 may activate the second converter 545 to generate the second DC (DC2). The second threshold may be less than the first threshold (e.g., 80% of the first threshold) at which the AC generator limits the power of the first AC (AC1). This allows the system to switch to a mode that can proactively supply power in anticipation of the load's future high power demand.

The controller 520 may open and close the first switch 561 based on the monitoring information (M). For example, if the required power detected from the monitoring information (M) is greater than or equal to the predetermined second threshold, the controller 520 may control the first switch 561 to close.

The controller 520 may control the opening and closing of the second switch 562. The controller 520 may control the opening and closing of the second switch 562 based on the monitoring information (M) and information received from at least one other power supply apparatus.

Conditions for closing the second switch 562 may include a first condition where the controller 520 determines, based on the monitoring information (M), that there is sufficient power capacity in the power supply apparatus to supply DC from the second converter 545 to the power bus, and a second condition where at least one other power supply apparatus requires power from the power supply apparatus via the power bus, based on information received from the other power supply apparatus. For example, the first condition may be that the current required power is below a predetermined value based on the monitoring information (M), and the charge amount of the energy storage unit 540 is above a predetermined value. The second condition may be met when power supply apparatus 500 receives, from at least one other power supply apparatus, information corresponding to the condition for closing its third switch or explicit power request, via the data paths (C1_2, . . . , and/or C1_N). Conditions for closing the third switch will be described later.

The controller 520 may control the opening and closing of the third switch 563. The controller 520 may control the third switch 563 based on the monitoring information (M) and the charge amount of the energy storage unit 540. In some embodiments, when the required power calculated from the monitoring information (M) is greater than or equal to a first predetermined value, and the charge level of the energy storage unit 540 is less than a second predetermined value, the controller 520 may close the third switch 563 to include the DC supplied from the power bus in the third DC (DC3). The first predetermined value may be the same as the aforementioned second threshold. The second predetermined value may be 30% of the full charge amount. In other embodiments, when the time during which the energy storage unit 540 can supply DC to the second converter 545 (e.g., the time until it is fully discharged) is within a predetermined time, the controller 520 may close the third switch 563 to include the DC supplied from the power bus in the third DC (DC3). This allows the system to switch to a mode that can proactively supply power in anticipation of the load's future high power demand.

The controller 520 may transmit the monitoring information (M) and the charge amount of the energy storage unit 540 of the power supply apparatus to which the controller 520 belongs to other power supply apparatuses via the data paths (C1_2, . . . , and/or C1_N). The other power supply apparatuses receiving this information can determine whether to open or close their second switches based on the received information. The method for determining whether to open or close the second switch is as described above.

The controller 520 may explicitly transmit a power request to other power supply apparatuses. The controller 520 may determine whether to request power supply based on the monitoring information (M) and the charge amount (e.g., state of charge) of the energy storage unit 540. For example, if the required power calculated from the monitoring information (M) is greater than or equal to a first predetermined value and the charge amount of the energy storage unit 540 is less than a second predetermined value, the controller 520 may transmit a power request to other power supply apparatuses via the data paths (C1_2, . . . , and/or C1_N).

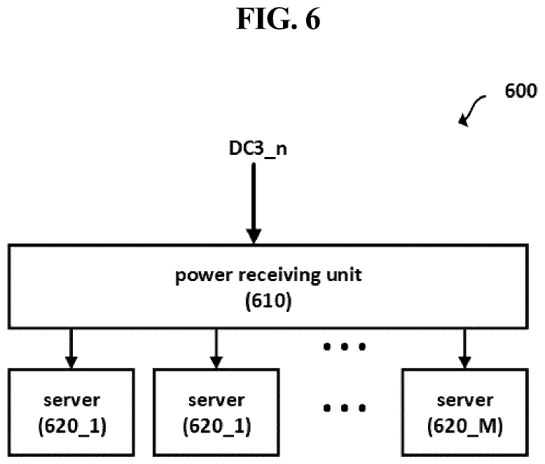

FIG. 6 is a block diagram illustrating other embodiments of a server system according to the present disclosure.

In some embodiments, as illustrated in FIG. 6, the server system 600 may include a power receiving unit 610 capable of receiving DC (e.g., third DC) generated by the power supply apparatus of the present disclosure and at least one server (620_1, 620_2, . . . , 620_M). In FIG. 6, M may be a natural number.

The server system 600 may be used as each server system 630n (where n is a natural number from 1 to N) in FIG. 4.

The power receiving unit 610 may include a DC bus connected to at least one server (620_1, 620_2, . . . , 620_M).

Referring to FIG. 6, by utilizing the power supply apparatus of the present disclosure, there may be an effect that the power receiving hardware of the server system can be simplified compared to corresponding hardware in conventional server systems.

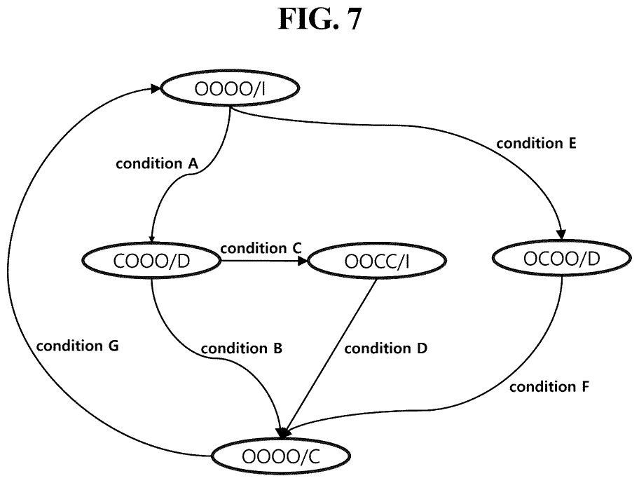

FIG. 7 is a state transition diagram illustrating some embodiments of power supply control according to the present disclosure.

All or some of the embodiments described in FIG. 7 may be performed by a controller according to the embodiments of the present disclosure (e.g., the embodiments illustrated in FIGS. 2, 5, etc.).

The controller of the power supply apparatus may control the opening and closing of the first switch, the second switch, and the third switch, and the charging of the energy storage unit, based on at least some of the monitoring information, the charge amount of the energy storage unit, and information provided from at least one of the at least one other power supply apparatuses.

The controller of the power supply apparatus may communicate with the at least one other power supply apparatus so that the opening and closing of the second switch of all or some of the at least one other power supply apparatuses can be controlled.

Examples of all or some of the at least one other power supply apparatuses are as follows. In a data center system including a first power supply apparatus, a second power supply apparatus, . . . , and an N-th power supply apparatus, the n-th power supply apparatus (where n is a natural number from 1 to N) may perform communication with M (a natural number from 1 to N−1) power supply apparatuses among the remaining N−1 power supply apparatuses so that the opening and closing of the second switches of the M power supply apparatuses can be controlled. Here, when M<N−1, M power supply apparatuses may be selected according to a predetermined selection method. For example, M power supply apparatuses with relatively spare capacity (e.g., those whose load's required power is low or those whose energy storage units have sufficient charge amount) among the remaining N−1 power supply apparatuses may be selected. In another example, M power supply apparatuses that are located relatively close to the n-th power supply apparatus among the remaining N−1 power supply apparatuses may be selected.

Examples of embodiments in which the controller of the power supply apparatus communicates with the respective power supply apparatuses so that the opening and closing of the second switch of all or some of the at least one other power supply apparatuses can be controlled as follows. In one embodiment, when the power supply apparatus provides its own status (e.g., monitoring information) to the other power supply apparatus, the other power supply apparatus may control its second switch according to corresponding logic based on that information and the information possessed by the other power supply apparatus. In another embodiment, the power supply apparatus may provide an explicit request signal to the other power supply apparatus to open or close the second switch in the other power supply apparatus, thereby controlling the opening and closing of the second switch of the other power supply apparatus.

In FIG. 7, to explain the control operations of the aforementioned controller, five states are illustrated, namely, the OOOO/I state, the COOO/D state, the OOCC/I state, the OCOO/D state, and the OOOO/C state.

For example, in the OOOO/I state, the first “OOO” indicates that the first to third switches of the power supply apparatus (e.g., the n-th power supply apparatus) are open (O), the fourth “O” indicates that the second switch of the nearest power supply apparatus (e.g., the (n+1)-th power supply apparatus) is open (O), and the last “I” indicates that the energy storage unit of the power supply apparatus operates in idle mode (e.g., mode being neither charge mode nor discharge mode).

In another example, the COOO/D state indicates that the first switch of the power supply apparatus is closed (C), the second and third switches of the power supply apparatus and the second switch of the nearest power supply apparatus are open (O), and the energy storage unit of the power supply apparatus operates in discharge mode (D).

In yet another example, the OOOO/C state indicates that the first to third switches of the power supply apparatus and the second switch of the nearest power supply apparatus are open (O), and the energy storage unit of the power supply apparatus operates in charge mode (C).

In some embodiments, each power supply apparatus may start in the OOOO/I state upon initialization. In the OOOO/I state, the first to third switches of the power supply apparatus are open, the second switch of the nearest power supply apparatus is open, and the energy storage unit of the power supply apparatus operates in idle mode. In this state, the load can receive an appropriate level of power (e.g., power less than the second threshold) from the AC generator without discharging (i.e., supplying energy to the load) the energy storage unit of the power supply apparatus.

In some embodiments, when condition A is satisfied in the OOOO/I state, a transition to the COOO/D state may occur. In the COOO/D state, the first switch of the power supply apparatus is closed, allowing the load to receive power from the AC generator and the energy storage unit. In one embodiment, condition A may include that the required power of the load corresponding to the power supply apparatus is equal to or greater than the second threshold. In another embodiment, condition A may include that the required power of the load corresponding to the power supply apparatus is equal to or greater than the second threshold, and the charge amount of the energy storage unit of the power supply apparatus is equal to or greater than a predetermined third threshold. An example of the third threshold is 30% of the full charge amount of the energy storage unit.

In some embodiments, when condition B is satisfied in the COOO/D state, a transition to the OOOO/C state may occur. In the OOOO/C state, the energy storage unit of the power supply apparatus may perform charging. In one embodiment, condition B may include that the required power of the load corresponding to the power supply apparatus is less than the second threshold. In another embodiment, condition B may include that the required power of the load corresponding to the power supply apparatus is less than the second threshold, and the charge amount of the energy storage unit of the power supply apparatus is less than the third threshold. For example, the controller may control the first switch to be closed in the COOO/D state, and then, when the required power detected based on the monitoring information becomes less than the second threshold, transition to the OOOO/C state, control the first switch to be open, and control the energy storage unit to be charged.

In some embodiments, when condition C is satisfied in the COOO/D state, a transition to the OOCC/I state may occur. In the OOCC/I state, the third switch of the power supply apparatus and the second switch of the nearest power supply apparatus are closed, allowing the load corresponding to the power supply apparatus to receive power provided from the nearest power supply apparatus through the power bus. In one embodiment, condition C may include that the required power of the load corresponding to the power supply apparatus is equal to or greater than the second threshold. In another embodiment, condition C may include that the required power of the load corresponding to the power supply apparatus is equal to or greater than the second threshold, and the charge amount of the energy storage unit of the power supply apparatus is less than the third threshold. For example, the controller may, in the COOO/D state, when the required power detected based on the monitoring information is equal to or greater than the predetermined second threshold and the charge amount of the energy storage unit is less than the predetermined third threshold, transition to the OOCC/I state and control the third switch to be closed.

In some embodiments, when condition D is satisfied in the OOCC/I state, a transition to the OOOO/C state may occur. In one embodiment, condition D may include that the required power of the load corresponding to the power supply apparatus is less than the second threshold. In another embodiment, condition D may include that the required power of the load corresponding to the power supply apparatus is less than the second threshold, and the charge amount of the energy storage unit of the power supply apparatus is less than the third threshold. For example, the controller may control the third switch to be closed in the OOCC/I state, and then, when the required power detected based on the monitoring information becomes less than the second threshold and the charge amount of the energy storage unit is less than the predetermined third threshold, transition to the OOOO/C state, control the third switch to be open, and control the energy storage unit to be charged.

In some embodiments, when condition E is satisfied in the OOOO/I state, a transition to the OCOO/D state may occur. In the OCOO/D state, the second switch of the power supply apparatus is closed, allowing the load corresponding to the nearest power supply apparatus to receive power provided from the power supply apparatus through the power bus. In one embodiment, condition E may include that the required power of the load corresponding to the power supply apparatus is less than the second threshold, and the required power of the load corresponding to the nearest power supply apparatus is equal to or greater than the second threshold. In another embodiment, condition E may include that the required power of the load corresponding to the power supply apparatus is less than the second threshold, the required power of the load corresponding to the nearest power supply apparatus is equal to or greater than the second threshold, and the charge amount of the energy storage unit of the nearest power supply apparatus is less than the third threshold. In yet another embodiment, condition E may include that the required power of the load corresponding to the power supply apparatus is less than the second threshold, the required power of the load corresponding to the nearest power supply apparatus is equal to or greater than the second threshold, the charge amount of the energy storage unit of the nearest power supply apparatus is less than the third threshold, and the charge amount of the energy storage unit of the power supply apparatus is equal to or greater than a predetermined fourth threshold. An example of the fourth threshold is 90% of the full charge value of the energy storage unit. For example, the controller may, in the OOOO/I state, when the required power detected based on the monitoring information is less than the predetermined second threshold, the required power of at least one other power supply apparatus is equal to or greater than the second threshold, and the charge level of the energy storage unit of at least one other power supply apparatus is less than the predetermined third threshold, transition to the OCOO/D state and control the second switch to be closed.

In some embodiments, when condition F is satisfied in the OCOO/D state, a transition to the OOOO/C state may occur. In one embodiment, condition F may include that the required power of the load corresponding to the power supply apparatus is less than the second threshold, and the required power of the load corresponding to the nearest power supply apparatus is less than the second threshold. In another embodiment, condition F may include that the required power of the load corresponding to the power supply apparatus is less than the second threshold, the required power of the load corresponding to the nearest power supply apparatus is less than the second threshold, and the charge amount of the energy storage unit of the nearest power supply apparatus is equal to or greater than the fourth threshold. In yet another embodiment, condition F may include that the required power of the load corresponding to the power supply apparatus is less than the second threshold, the required power of the load corresponding to the nearest power supply apparatus is less than the second threshold, the charge amount of the energy storage unit of the nearest power supply apparatus is equal to or greater than the fourth threshold, and the charge amount of the energy storage unit of the power supply apparatus is less than the third threshold. For example, the controller may control the second switch to be closed in the OCOO/D state, and then, when the required power detected based on the monitoring information becomes less than the second threshold, the required power of at least one other power supply apparatus becomes less than the second threshold, and the charge amount of the energy storage unit of at least one other power supply apparatus becomes equal to or greater than the predetermined fourth threshold, transition to the OOOO/C state and control the energy storage unit to be charged.

In some embodiments, when condition G is satisfied in the OOOO/C state, a transition to the OOOO/I state may occur. In one embodiment, condition G may include that the required power of the load corresponding to the power supply apparatus is less than the second threshold. In another embodiment, condition G may include that the required power of the load corresponding to the power supply apparatus is less than the second threshold, and the charge level of the energy storage unit of the power supply apparatus is equal to or greater than the fourth threshold.

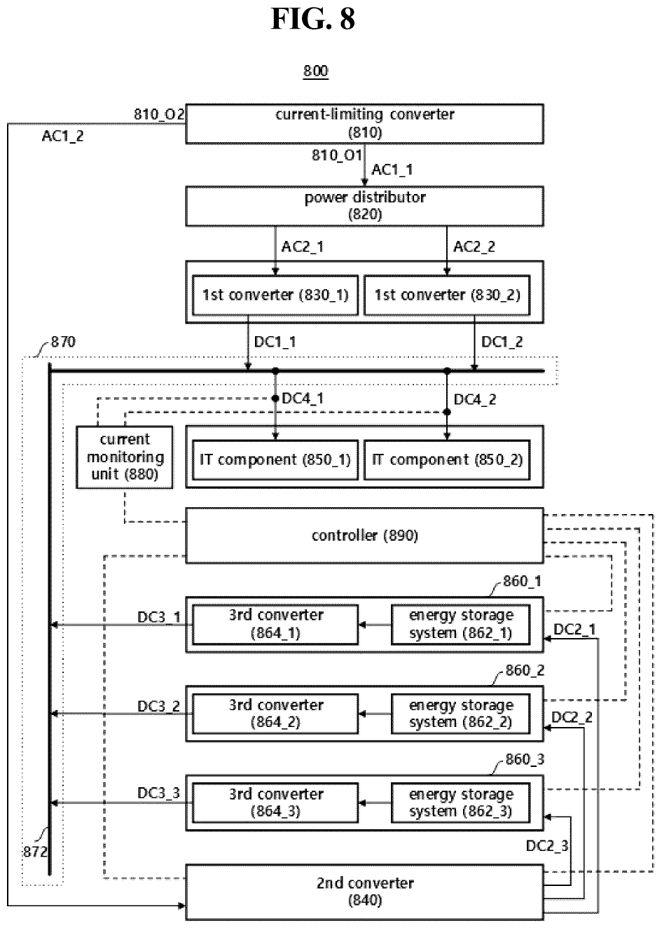

FIG. 8 is a block diagram illustrating some embodiments of the system according to the present disclosure.

In some embodiments, as illustrated in FIG. 8, the system 800 may include at least some of a current-limiting converter 810, a power distributor 820, first converters 830_1 and 830_2, a second converter 840, IT components 850_1 and 850_2, energy storage units 860_1, 860_2, and 860_3, a DC supplying unit 870, a current monitoring unit 880, and a controller 890.

Hereinafter, some embodiments will be described based on a system 800 in which the number (L) of first converters 830_1 and 830_2, the number (M) of IT components 850_1 and 850_2, and the number (N) of energy storage units 860_1, 860_2, and 860_3 are set to 2, 2, and 3, respectively, as illustrated in FIG. 8. However, it should be fully understood by those skilled in the art that various embodiments may exist in various combinations regarding the numbers of L, M, N, and other components.

Also, in FIG. 8, the IT components 850_1 and 850_2 are considered devices that consume a large amount of power, so the power delivery paths are mainly illustrated focusing on these components, and for convenience, the power delivery paths for other modules (e.g., the controller) are omitted. It should be fully understood by those skilled in the art that other modules (e.g., the controller) can also receive power through all or some of the outputs of the current-limiting converter 810, the power distributor unit 820, the outputs of the first converters 830_1 and 830_2, and the outputs of the energy storage units 860_1, 860_2, and 860_3.

In addition, the dotted lines in FIG. 8 represent signaling paths (i.e., data transmission paths or control signal transmission paths) rather than power delivery paths. For example, the controller 890 may receive information (e.g., current measurements, status information of the second converter, charge amounts of the energy storage units) from the current monitoring unit 880, the second converter 840, and the energy storage units 860_1, 860_2, and 860_3, or may perform control over these units.

In some embodiments, the system 800 may further include an electronic equipment rack capable of mounting at least some of the current-limiting converter 810, the power distributor 820, the first converters 830_1 and 830_2, the second converter 840, the IT components 850_1 and 850_2, the energy storage units 860_1, 860_2, and 860_3, the DC supplying unit 870, the current monitoring unit 880, and the controller 890.

The current-limiting converter 810 may receive power from an AC power source (not shown). For example, the AC power source may be an AC grid. In another example, the AC power source may be the power supply apparatus 200 illustrated in FIG. 2. In the latter case, although it may be more complex than the former, it can provide a more stable AC supply compared to the former through various responses to power supply failures of the AC grid (e.g., utilizing energy storage units and first to third switches).

The current-limiting converter 810 may output first AC (AC1_1, AC1_2) through at least one of a first output 810_O1 and a second output 810_O2 based on the power provided from the AC power source, and may limit the total power of the output first AC power to be below a predetermined first threshold (hereinafter, maximum power threshold).

For example, the current-limiting converter 810 may output the first AC power (AC1_1, AC1_2) by limiting the total power output through the first output 810_O1 and the second output 810_O2 to 10 kW or less.

Unlike a circuit breaker that completely cuts off the current supply when the threshold current is exceeded and requires a recovery process after interruption, the current-limiting converter 810 can ensure that components receiving power, such as the IT components 850_1 and 850_2, can operate continuously by providing AC power that limits the maximum power threshold.

The first converters 830_1 and 830_2 may convert AC based on the first output 810_O1 into DC and output first DC (DC1_1, DC1_2).

The power distributor 820 may distribute the first AC (AC1_1) output through the first output 810_O1 of the AC power source, and output second AC (AC2_1, AC2_2) for each of the first converters 830_1 and 830_2. This output second AC (AC2_1, AC2_2) may be converted into first DC (DC1_1, DC1_2) through the first converters 830_1 and 830_2.

The power distributor 820 may equally divide the first AC (AC1_1) and provide it to each of the first converters 830_1 and 830_2. For example, when the power of the first AC (AC1_2) output through the second output 810_O2 is zero, the maximum power of the first AC (AC1_1) output through the first output 810_O1 may be equal to the maximum power threshold (e.g., 10 kW) of the current-limiting converter 810. In this case, the maximum power of each of the second AC (AC2_1, AC2_2) provided to the first converters 830_1 and 830_2 may be 5 kW.

The second converter unit 840 may convert the first AC (AC1_2) based on the second output 810_O2 into DC and output second DC (DC2_1, DC2_2, DC2_3).

The second converter 840 may distribute the second DC (DC2_1, DC2_2, DC2_3) to the energy storage units 860_1, 860_2, and 860_3 under the control of the controller 890, thereby controlling the charging of each energy storage unit.

The second conversion unit 840 may be an AC-DC charger.

The IT components 850_1 and 850_2 may be power-consuming devices (e.g., servers, network equipment) among the equipment mounted on the electronic equipment rack.

In some embodiments, at least some of the IT components 850_1 and 850_2 may include AI inference servers. Although AI inference servers consume high power and have irregular and unpredictable power consumption patterns, through some embodiments of the present disclosure, a data center including AI inference servers can be operated stably at low cost.

In some embodiments, the number (L) of first converters 830_1 and 830_2 and the number (M) of IT components 850_1 and 850_2 may have the same value (2), as shown in FIG. 8.

The energy storage units 860_1, 860_2, and 860_3 may charge power based on the second DC (DC2_1, DC2_2, DC2_3), and discharge the charged power to output third DC (DC3_1, DC3_2, DC3_3).

In some embodiments, as illustrated in FIG. 8, each of the energy storage units 860_1, 860_2, and 860_3 may include an energy storage system 862_1, 862_2, and 862_3 and third converters 864_1, 864_2, and 864_3.

The energy storage systems 862_1, 862_2, and 862_3 may charge power based on the second DC (DC2_1, DC2_2, DC2_3).

In some embodiments, the energy storage systems 862_1, 862_2, and 862_3 may include at least one energy storage cell that uses a material other than a metal oxide as the cathode material. In some embodiments, the energy storage system 862_1, 862_2, and 862_3 may include a supercapacitor. In some embodiments, the energy storage system 862_1, 862_2, and 862_3 may include an energy storage cell (e.g., lithium-ion capacitor) as described above in FIG. 2. Through this, the effects described in FIG. 2 can be obtained.

The third converters 864_1, 864_2, and 864_3 may convert the DC power obtained by discharging the power charged in the energy storage systems 862_1, 862_2, and 862_3 into third DC (DC3_1, DC3_2, DC3_3) and output it.

The third converters 864_1, 864_2, and 864_3 may stably regulate the DC current value without substantial voltage changes. For example, the third converters 864_1, 864_2, and 864_3 may output the third DC (DC3_1, DC3_2, DC3_3) maintained at a specific voltage (e.g., 12V or 48V) from a voltage range that the energy storage systems 862_1, 862_2, and 862_3 may have (e.g., between 10V and 14V or between 40V and 52V). For example, the current value of the third DC output from the third converters 864_1, 864_2, and 864_3 may vary under the control of the controller 890.

The DC supplying unit 870 may combine the first DC (DC1_1, DC1_2) and the third DC (DC3_1, DC3_2, DC3_3), and provide fourth DC (DC4_1, DC4_2) for each of the IT components 850_1 and 850_2.

In some embodiments, as illustrated in FIG. 8, the DC supplying unit 870 may include a power bus bar (872) connected to the outputs of each of the first converters 830_1 and 830_2 and the outputs of each of the energy storage units 860_1, 860_2, and 860_3, and connected to the inputs of each of the IT components 850_1 and 850_2. In other embodiments, instead of the power bus bar (872), the outputs of each of the energy storage units may be connected via individual cables to the outputs of each of the first converters, combining the first DC and the third DC to provide the fourth DC to each IT component.

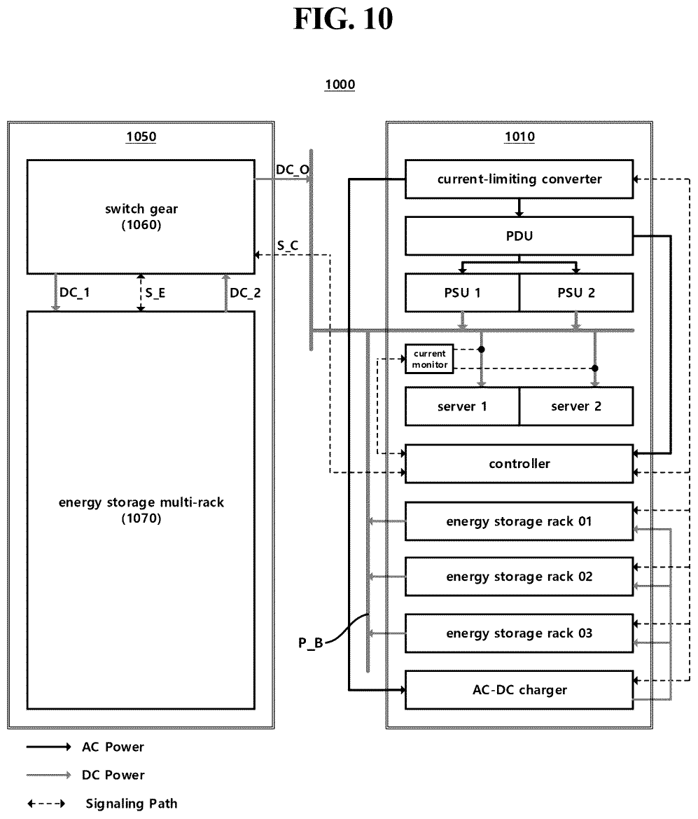

In some embodiments, the DC supplying unit 870 may receive supplemental DC power from a separate apparatus (e.g., the power supply apparatus illustrated in FIG. 5, or the power supply dedicated rack to be described later through FIG. 10) to provide supplemental power to the IT components.

The controller 890 may control the energy storage units 860_1, 860_2, and 860_3 based on the current power consumption of the IT components 850_1 and 850_2.

The current monitoring unit 880 may measure the fourth DC input to each of the IT components, and the controller 890 may perform appropriate control by determining the current power consumption of the IT components based on the current measurements provided.

If there is at least one IT component (hereinafter, over-power component) whose current power consumption is equal to or exceeds a predetermined second threshold (hereinafter, excess consumption power threshold), the controller 890 may control at least one of the energy storage units 860_1, 860_2, and 860_3 to operate in discharge mode. For example, the controller 890 may activate the third conversion units to control the corresponding energy storage units to operate in discharge mode.

The controller 890 may control at least one of the energy storage units 860_1, 860_2, and 860_3 operating in discharge mode so that each over-power component can receive power based on the first AC and power based on the third DC at a predetermined ratio (e.g., 1:K, where K is a positive real number such as 0.2, hereinafter, power supply ratio).

Each of the energy storage unit (860_1, 860_1, 860_2) currently responsible for an over-power component may output the third DC with power equal to the current power consumption of the corresponding component multiplied by a predetermined constant (e.g., K/(1+K)). For example, the controller 890 may control the third converter of each energy storage unit (860_1, 860_1, 860_2) currently responsible for each over-power component to output third DC (DC3_1, DC3_2, DC3_3) with power equal to the current power consumption of the corresponding over-power component multiplied by the predetermined constant.

In some embodiments, when there is an energy storage unit having a charge amount less than a predetermined third threshold (hereinafter, discharge prohibition threshold) among the energy storage units operating in discharge mode, the controller 890 may control that energy storage unit to operate in a mode other than discharge mode, and control at least one of the remaining energy storage units operating in a mode other than discharge mode to operate in discharge mode.

In some embodiments, the second threshold may be less than the value of the first threshold divided by M. For example, the second threshold may be less than 80% of the value of the first threshold divided by M. This can achieve the effect of being able to prepare for future rapid increases in power requirements by performing preemptive switching to discharge mode. Additionally, problems with the energy storage system caused by frequent discharge mode switching due to preemptive discharge mode switching can be solved through the use of LIC according to other embodiments.

In some embodiments, when all IT components 850_1, 850_2 have current power consumption less than the second threshold, the controller 890 may control all energy storage units 860_1, 860_2, 860_3 to operate in a mode other than discharge mode. For example, the controller 890 may control the corresponding energy storage unit 860_1, 860_2, or 860_3 to operate in a mode other than discharge mode by deactivating the third converters 864_1, 864_2, or 864_3.

In some embodiments, when all IT components (850_1, 850_2) have current power consumption less than the second threshold, the controller 890 may control the second converter 840 so that energy storage units needing charging among the energy storage units 860_1, 860_2, 860_3 can be charged.

In some embodiments, the system 800 may further include a power supply apparatus (e.g., power supply dedicated rack 1050 to be described later through FIG. 10) that provides fifth DC (e.g., DC_O of FIG. 10) to the DC supplying unit 870. The power supply apparatus may include K (a natural number greater than N) second energy storage systems (e.g., 1070 of FIG. 10), and the fifth DC may be based on discharge of at least some of the K second energy storage systems. In some embodiments, the second energy storage systems may include energy storage cells (e.g., lithium ion capacitors, etc.) as described above in FIG. 2. This may provide the effects described above in FIG. 2.

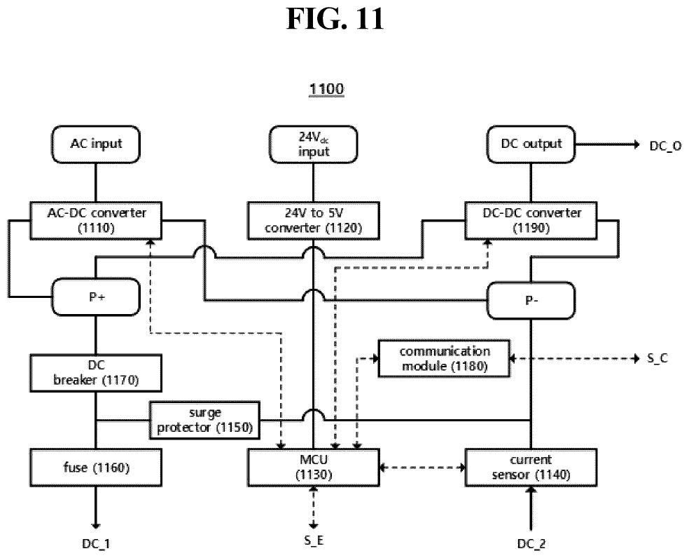

In some embodiments, the power supply apparatus may further include: a fourth converter (e.g., 1190 of FIG. 11) that generates the fifth DC by converting output current of the K second energy storage systems; and a second controller (e.g., 1130 of FIG. 11) that controls discharge of the K second energy storage systems through activation control of the fourth converter.

In some embodiments, the power supply apparatus may further include a second communication unit (e.g., 1180 of FIG. 11) capable of communicating with the controller (890), and the second controller may perform activation control of the fourth converter based on information received from the second communication unit.

In some embodiments, the power supply apparatus may further include a second current monitoring unit (e.g., 1140 of FIG. 11) that monitors output current of the K second energy storage systems, and the second controller may perform activation control of the fourth converter based on the output current monitored by the second current monitoring unit.

In some embodiments, the output (DC_O) of the fourth converter may be connected to the power bus bar 872, allowing the fifth DC to be combined with the first DC and the third DC.

In some embodiments, the system 800 may further include: a first electronic equipment rack capable of mounting at least some of the modules shown in FIG. 8 (e.g., current-limiting converter, L first converters, second converter, M IT components, N energy storage units, DC supplying unit, the controller, etc.); and a second electronic equipment rack capable of mounting at least some of the modules of the aforementioned power supply apparatus (e.g., the fourth converter, the second controller, and the K second energy storage systems). In some embodiments, K may have a value greater than N.

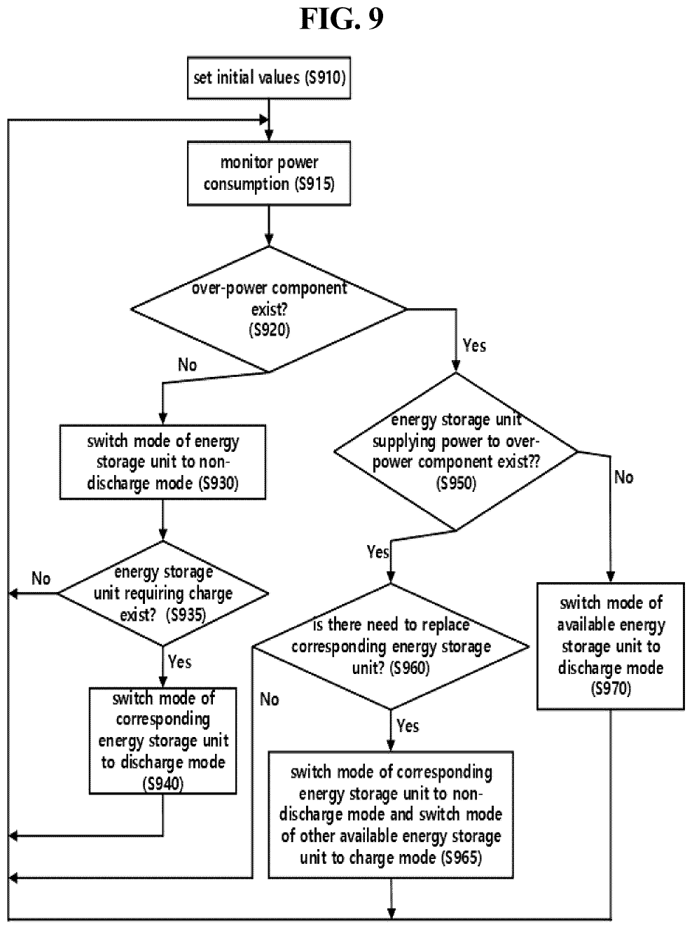

FIG. 9 is a flowchart illustrating some embodiments of the operation of the system according to the present disclosure.

In the following description, some embodiments will be explained based on the system (800) shown in FIG. 8 for convenience, but those skilled in the art would readily understand that the operations of the present disclosure may be applied to other systems as well.

In some embodiments, as illustrated in FIG. 9, initial values for the system (800) may be set (S910).

In S910, various parameter values may be set, including maximum power threshold, excess consumption power threshold, discharge start enable threshold, discharge prohibition threshold, charging unnecessary threshold, and power supply ratio. The maximum power threshold (e.g., 10 kW), excess consumption power threshold (e.g., 3.5 kW), discharge prohibition threshold (e.g., 30% of full charge), and power supply ratio (e.g., 1:0.2) are as described above.

The discharge start enable threshold may be the minimum charge amount (e.g., 50% of full charge) that allows an energy storage unit operating in a mode other than discharge mode to switch to discharge mode. The charging unnecessary threshold may be the minimum charge amount (e.g., 90% of full charge) that allows an energy storage unit to be considered as not requiring charging.

For example, when an energy storage unit operating in charge mode reaches a charge amount above the charging unnecessary threshold, it may switch to a mode other than charge mode. In another example, even when there is no over-power component, an energy storage unit (860_1, 860_2, and/or 860_3) with a charge amount above the charging unnecessary threshold may not switch to charge mode.

In some embodiments, after system (800) initial values are set (S910), the process may proceed to S920 when predetermined conditions (normal operation start conditions) are met. As an example of normal operation start conditions, all energy storage units (860_1, 860_2, 860_3) may satisfy certain conditions (for example, having a charge amount above the charging unnecessary threshold, or in another example, having a charge amount above the discharge start enable threshold). As another example of normal operation start conditions, each IT component's (850_1, 850_2) current power consumption may be less than the excess consumption power threshold.

For convenience, some embodiments will be explained assuming these two conditions are already satisfied when S920 operation is first executed.

In some embodiments, as illustrated in FIG. 9, the controller (890) may monitor current power consumption of each IT component (850_1, 850_2) (S920). The current monitoring unit (880) may measure the fourth DC input to each IT component (850_1, 850_2), and the controller (890) may make judgments about the current power consumption of IT components (850_1, 850_2) based on current measurements provided by the current monitoring unit (880) to perform corresponding control.

In some embodiments, when current power consumption of at least one IT component (850_1, 850_2) (e.g., 850_1) becomes equal to or greater than the excess consumption power threshold (S920), the controller (890) may proceed to S950.

In S950, The controller (890) may determine whether there is already an energy storage unit (860_1, 860_2, 860_3) supplementing power to the corresponding over-power component (e.g., 850_1).

In some embodiments, as illustrated in FIG. 9, when the controller (890) determines that there is not yet an energy storage unit (860_1, 860_2, 860_3) supplementing power to the corresponding over-power component (e.g., 850_1) (S950), it may proceed to S970.

In S970, the controller (890) may switch at least one available energy storage unit (hereinafter, available energy storage unit) capable of supplementing power to the corresponding over-power component (e.g., 850_1) to discharge mode.

The controller (890) may determine as available energy storage units those energy storage units among (860_1, 860_2, 860_3) that have charge amount at or above the discharge start enable threshold.

When there are multiple available energy storage units, the controller (890) may select only some of them to switch to discharge mode. For example, the controller (890) may select some units with the highest charge amounts among multiple available energy storage units. In another example, the controller (890) may select some units corresponding to their turn (e.g., round-robin method) among multiple available energy storage units. For example, an energy storage unit (e.g., 860_1) switched to discharge mode in this way can supply the power deficit of the corresponding over-power component (e.g., 850_1) by providing third DC (e.g., DC3_1) to the DC supplying unit (870).

In some embodiments, the controller (890) may control at least one energy storage unit (e.g., 860_1) operating in discharge mode so that each over-power component (e.g., 850_1) can receive power based on first AC (AC1_1) and power based on third DC (e.g., DC3_1) in the power supply ratio (e.g., 1:0.2). For example, each energy storage unit (e.g., 860_1) currently responsible for each over-power component (e.g., 850_1) among energy storage units (860_1, 860_2, 860_3) may output third DC (e.g., DC3_1) with power equal to the current power consumption of the corresponding excess power component (e.g., 850_1) multiplied by a predetermined constant (e.g., 0.2/(1+0.2)).

In some embodiments, as illustrated in FIG. 9, after switching available energy storage units to discharge mode (S970), the controller (890) may return to S915.

In some embodiments, as illustrated in FIG. 9, when the controller (890) determines that an over-power component (e.g., 850_1) exists (S920) and confirms that there is an energy storage unit (e.g., 860_1) supplementing power to the corresponding over-power component (S950), it may proceed to S960. For example, this case may occur when an IT component (850_1) continuously consumes high power.

In some embodiments, as illustrated in FIG. 9, if there is no need to replace the energy storage unit (e.g., 860_1) supplementing power to the corresponding excess power component (e.g., 850_1) (S960), the controller (890) may return to S915. For example, when the charge amount of the energy storage unit (e.g., 860_1) supplementing power to the corresponding over-power component (e.g., 850_1) is at or above the discharge prohibition threshold, the controller (890) may return to S915.

In some embodiments, as illustrated in FIG. 9, when there is a need to replace the energy storage unit (e.g., 860_1) supplementing power to the corresponding over-power component (e.g., 850_1) (S960), the controller (890) may switch that energy storage unit (e.g., 860_1) to a mode other than discharge mode, switch all or some of the available energy storage units (e.g., 860_2) among the remaining energy storage units (e.g., 860_2, 860_3) to discharge mode to supplement power to the corresponding over-power component (e.g., 850_1) (S965), and then return to S915. Here, when there are multiple available energy storage units, the method for selecting only some of them to switch to discharge mode is as described in S970.

In some embodiments, as illustrated in FIG. 9, when the controller (890) determines that no over-power component exists (e.g., 850_1) (S920), the controller (890) may proceed to S930. For example, this case may occur when an over-power component (e.g., 850_1) that was receiving supplemental power through energy storage units (e.g., 860_1 or 860_2) now has current power consumption below the excess consumption power threshold, or when there are no over-power components at both the previous and current monitoring points.

In S930, if there are energy storage units operating in discharge mode (e.g., 860_1 or 860_2 as described above), the controller (890) may switch them to a mode other than discharge mode.

In some embodiments, as illustrated in FIG. 9, the controller (890) may determine whether there are any energy storage units (860_1, 860_2, 860_3) requiring charging (S935). The controller (890) may determine as energy storage units requiring charging, those energy storage units among (860_1, 860_2, 860_3) that have a charge amount below the charging unnecessary threshold.

In some embodiments, as illustrated in FIG. 9, when the controller (890) determines that no energy storage units (860_1, 860_2, 860_3) require charging (S935), it may return to S915.

In some embodiments, as illustrated in FIG. 9, when energy storage units (860_1, 860_2, 860_3) requiring charging exist (S935), the controller (890) may maintain the current mode if the corresponding energy storage unit is already operating in charge mode, and switch it to charge mode if corresponding energy storage unit is operating in mode other than charge mode (S940), and then return to S915. For example, as described above, energy storage units (e.g., 860_1 and/or 860_2) that have reached a charge amount below the charging unnecessary threshold due to supplemental power supply to over-power components (e.g., 850_1) may be switched to charge mode (S940).

FIG. 10 is a block diagram illustrating further embodiments of a data center according to the present disclosure.

In some embodiments, as illustrated in FIG. 10, a data center (1000) may include at least one electronic equipment rack (1010) and at least one power supply dedicated rack (1050).

In some embodiments, the electronic equipment rack (1010) may include modules according to some embodiments of FIG. 8. For example, server 1 and 2 of FIG. 10 may correspond to IT components (850_1, 850_2) of FIG. 8. In another example, the controller of FIG. 10 may correspond to the controller (890) of FIG. 8, and the energy storage racks (energy storage rack 01, 02, 03) of FIG. 10 may correspond to the energy storage systems (862_1, 862_2, 862_3) of FIG. 8. In another example, the current monitor of FIG. 10 may correspond to the current monitoring unit (880) of FIG. 8, and the AC-DC charger of FIG. 10 may correspond to the second converter (840) of FIG. 8. In yet another example, PSU 1 and 2 of FIG. 10 correspond to the first converters (830_1, 830_2) of FIG. 8, and the PDU of FIG. 10 may correspond to the power distributor (820) of FIG. 8. In still another example, the current-limiting converter of FIG. 10 may correspond to the current-limiting converter (810) of FIG. 8. In another example, the power bus (P_B) of FIG. 10 may correspond to the power bus bar (872) of FIG. 8.

In some embodiments, the power supply dedicated rack (1050) may include, as illustrated in FIG. 10, a switch gear (1060) and an energy storage multi-rack (1070). The energy storage multi-rack (1070) may include multiple energy storage racks (e.g., 1070_1, . . . , 1070_K) containing the aforementioned energy storage systems.
the switch gear (1060) may provide DC to server 1 and 2 of the electronic equipment rack (1010) based on DC from multiple energy storage racks (1070_1, . . . , 1070_K). In some embodiments, the DC provision from the switch gear (1060) to server 1 and 2 may be performed, as illustrated in FIG. 10, by the switch gear (1060) providing DC based on energy storage multi-rack (including energy storage racks 1070_1, . . . , 1070_K, not shown) to the power bus (P_B).

In some embodiments, the number K of energy storage racks included in the power supply dedicated rack (1050) may be greater than the number N of energy storage racks included in the electronic equipment rack (1010) (in the case of FIG. 10, 3). Through this, when power supply failure occurs in the electronic equipment rack (e.g., when a problem occurs in the path from the AC power source and current-limiting converter to the server), the energy storage racks included in the electronic equipment rack (1010) can provide first-response power supply to the servers for a short time, and if this first response is insufficient, a sufficient number of energy storage racks included in the power supply dedicated rack (1050) can provide second-response power supply to the servers for a long time.

The switch gear (1060) may exchange information with the controller of the electronic equipment rack (1010) through a signaling path (S_C). For example, the electronic equipment rack (1010) may transmit energy status information (e.g., server energy consumption, energy storage rack charge amount, other energy shortage information) or energy supply requests to the switch gear (1060).

FIG. 11 is a block diagram illustrating further embodiments of a power supply technology according to the present disclosure.

In some embodiments, the power supply apparatus (1100) of FIG. 11 may correspond to the switch gear (1060) of FIG. 10.

In some embodiments, as illustrated in FIG. 11, the power supply apparatus (1100) may include an AC-DC converter (1110), a 24 to 5V converter (1120), a microcontroller unit (MCU) (1130), a current sensor (1140), a surge protector (1150), a fuse (1160), a DC breaker (1170), a communication module (1180), and a DC-DC converter (1190).

The AC-DC converter (1110) may receive AC through AC Input from an AC power source (e.g., AC grid) and convert it to DC. The converted current may be provided to energy storage systems (e.g., energy storage systems included in each of the multiple energy storage racks of the energy storage multi-rack illustrated in FIG. 10) through the DC breaker (1170) and fuse (1160). Each energy storage system may receive DC through the fuse (1160) and charge energy.

The DC breaker (1170) may be a resettable mechanical interruption device for overcurrent in DC circuits, and the fuse (1160) may be a one-time protection device that melts to interrupt the circuit during overcurrent. Meanwhile, the surge protector (1150) may be a device that disperses voltage spikes to protect equipment without interrupting the circuit.

The power supply apparatus (1100) according to some embodiments can provide stable DC flow by having the DC breaker (1170), fuse (1160), and surge protector (1150) arranged in the structure illustrated in FIG. 11.

The communication module (1180) may receive energy status information (e.g., server energy consumption, energy storage rack charge amount, other energy shortage information) or energy supply requests from the electronic equipment rack (1010) through the signaling path (S_C).

The current sensor (1140) may monitor output current of the energy storage device.

The MCU (1130) may receive power from the 24V to 5V converter (1120) and perform monitoring and/or control of modules within the power supply apparatus (1100) through signaling paths. For example, the MCU (1130) may control the DC-DC converter (1190) based on information provided from the communication module (1180) through the signaling path to cause the energy storage device to discharge. In another example, the MCU (1130) may determine whether the discharge of the energy storage system (e.g., energy storage system in multiple energy storage racks 1070 in FIG. 10) is proceeding as planned based on monitoring information provided through the current sensor, and control the DC-DC converter (1190) according to that determination. In yet another example, the MCU (1130) may monitor the charging state (charge amount, etc.) of each energy storage system and control the AC-DC converter (1110) based on those results to allow the energy storage system to charge.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer and may be implemented as various recording media such as a magnetic storage medium, an optical reading medium, and a digital storage medium.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A power supply apparatus for supplying power to at least one load, comprising:
an AC generator configured to generate a first alternating current (AC);
a first converter configured to convert at least a portion of the first AC into a first direct current (DC);
an energy storage unit configured to charge energy based on the first AC;
a second converter configured to convert DC provided from the energy storage unit into a second DC;
a DC supplying unit capable of providing a third DC, which includes the first DC and the second DC, to the at least one load;
a monitoring unit configured to provide monitoring information for detecting the required power of the at least one load; and
a controller configured to control at least one of the second converter and the DC supplying unit based on the monitoring information.

2. The power supply apparatus of claim 1, wherein the AC generator generates the first AC by limiting power of the first AC to be equal to or less than a predetermined first threshold.

3. The power supply apparatus of claim 1, wherein the monitoring unit measures the current of the third DC provided to the at least one load, and the monitoring information includes information about the measured current.

4. The power supply apparatus of claim 1, wherein the controller activates the second converter to generate the second DC when the detected required power is equal to or greater than a predetermined second threshold.

5. The power supply apparatus of claim 4, wherein the AC generator generates the first AC by limiting power of the first AC to be equal to or less than a predetermined first threshold, and the first threshold is greater than the second threshold.

6. The power supply apparatus of claim 1, wherein the DC supplying unit comprises:
a first power delivery path connecting the first converter and the at least one load so that the first DC can be delivered to the at least one load;
a second power delivery path connecting the output of the second converter to a first junction point being a point included in the first power delivery path where the first DC and the second DC can be combined; and
a first switch for opening and closing the second power delivery path.

7. The power supply apparatus of claim 6, wherein the controller controls the opening and closing of the first switch based on the monitoring information.

8. The power supply apparatus of claim 7, wherein the controller controls the first switch to close when the detected required power based on the monitoring information is equal to or greater than the predetermined second threshold.

9. The power supply apparatus of claim 8, wherein, after controlling the first switch to close, the controller controls the first switch to open when the detected required power based on the monitoring information becomes less than the second threshold, and controls the energy storage unit so that the energy storage unit can be charged.

10. The power supply apparatus of claim 1, wherein the power supply apparatus shares a power bus with at least one other power supply apparatus, wherein the power supply apparatus further comprises a third power delivery path connecting the output of the second converter and the power bus so that the second DC can be delivered to the power bus; and a fourth power delivery path for providing power from the power bus to the at least one load.

11. The power supply apparatus of claim 10, further comprising a second switch for opening and closing the third power delivery path, wherein the controller controls the opening and closing of the second switch.

12. The power supply apparatus of claim 11, wherein the controller controls the opening and closing of the second switch based on the monitoring information and information received from at least one of the at least one other power supply apparatus.

13. The power supply apparatus of claim 11, wherein the controller controls the second switch to close when the detected required power based on the monitoring information is less than the predetermined second threshold, required power of the at least one other power supply apparatus is equal to or greater than the second threshold, and charge amount of the energy storage unit of the at least one other power supply apparatus is less than a predetermined third threshold.

14. The power supply apparatus of claim 13, wherein, after controlling the second switch to close, the controller controls the energy storage unit so that the energy storage unit can be charged when the detected required power based on the monitoring information remains less than the second threshold, the required power of the at least one other power supply apparatus becomes less than the second threshold, and the charge amount of the energy storage unit of the at least one other power supply apparatus becomes equal to or greater than a predetermined fourth threshold.

15. The power supply apparatus of claim 10, further comprising a third switch for opening and closing the fourth power delivery path, wherein the controller controls the opening and closing of the third switch.

16. The power supply apparatus of claim 15, wherein the controller controls the opening and closing of the third switch based on the monitoring information and charge amount of the energy storage unit.

17. The power supply apparatus of claim 15, wherein the controller controls the third switch to close when the detected required power based on the monitoring information is equal to or greater than the predetermined second threshold and the charge amount of the energy storage unit is less than a predetermined third threshold.

18. The power supply apparatus according to claim 17, wherein the controller, after controlling the third switch to close,
when the required power detected based on the monitoring information is less than the second threshold and the charge amount of the energy storage unit is less than the third threshold, controls the third switch to open, and controls the energy storage unit so that the energy storage unit can be charged.

19. The power supply apparatus of claim 10, wherein the DC supplying unit further comprises:
a first power delivery path connecting the first converter and the at least one load so that the first DC can be delivered to the at least one load;
a second power delivery path connecting the output of the second converter to a first junction point being a point included in the first power delivery path where the first DC and the second DC can be combined; and
a first switch for opening and closing the second power delivery path,
wherein the fourth power delivery path comprises a path connecting the power bus and a second junction point being a point included in the first power delivery path, and
wherein the third DC further includes DC provided from the power bus to the second junction point.

20. The power supply apparatus of claim 1, wherein the energy storage unit comprises:
a third converter configured to convert at least a portion of the first AC into DC; and
an energy storage system that charges energy using the DC supplied from the third converter.

21. The power supply apparatus of claim 20, wherein the energy storage system comprises at least one energy storage cell using a material other than a metal oxide as a cathode active material.

22. The power supply apparatus of claim 20, wherein the energy storage system comprises at least one energy storage cell that stores energy without using a chemical reaction at the cathode.

23. The power supply apparatus of claim 20, wherein the energy storage system comprises a Lithium Ion Capacitor (LIC).

24. The power supply apparatus of claim 1, wherein the at least one load comprises at least one server system, and the at least one server system includes at least one server.

25. A data center system comprising:
at least one subsystem; and
at least one server system receiving power from the at least one subsystem,
wherein each of the at least one subsystem comprises:
an AC generator configured to generate a first AC;
a first converter configured to convert at least a portion of the first AC into a first DC;
an energy storage unit configured to charge energy based on the first AC;
a second converter configured to convert DC provided from the energy storage unit into a second DC; and
a DC supplying unit capable of providing a third DC, which includes the first DC and the second DC, to the corresponding server system,
wherein each of the at least one server system comprises:
a power receiving unit capable of receiving the third DC; and
at least one server.

26. The data center system of claim 25,
wherein each of the at least one subsystem further comprises:
a monitoring unit configured to provide monitoring information for detecting the required power of the at least one server; and
a controller configured to control at least one of the second converter and the DC supplying unit based on the monitoring information.

27. The data center system of claim 25, wherein the power receiving unit comprises a DC bus connected to the at least one server.
